(19) United States
(12) Patent Application Publication
(10) Pub. No.: US 2026/0225869 A1
(43) Pub. Date: Aug. 6, 2026

(54) HANDLING ROBOT

(71) Applicant: BEIJING GEEKPLUS TECHNOLOGY CO., LTD., Beijing (CN)

(72) Inventors: Li YUAN, Beijing (CN); Yuhui XIAO, Beijing (CN); Yinghui XIONG, Beijing (CN); Tingkai ZHANG, Beijing (CN); Jianpeng MA, Beijing (CN)

(21) Appl. No.: 19/149,521

(22) PCT Filed: Jan. 15, 2024
(86) PCT No.: PCT/CN2024/072385

§ 371 Date: Jul. 18, 2025

(30) Foreign Application Priority Data
Jan. 19, 2023 (CN) 202310097556.6
Jan. 19, 2023 (CN) 202320181626.1
Mar. 3, 2023 (CN) 202320397956.4
Jul. 27, 2023 (CN) 202322000066.8
Oct. 17, 2023 (CN) 202322779739.4

(51) Int. Cl. B66F 9/065; B66F 7/06

(52) U.S. Cl. CPC B66F 9/065; B66F 7/065

(57) ABSTRACT

A handling robot includes: a chassis assembly, configured to be supported on a working surface; a tray assembly, disposed above the chassis assembly and configured to bear a container; a scissor lift assembly, disposed between the chassis assembly and the tray assembly and configured to drive the tray assembly up or down relative to the chassis assembly; a driving device, configured to drive movement of the scissor lift assembly to drive the tray assembly up or down relative to the chassis assembly; and a supporting part, configured to support the tray assembly in a case where the tray assembly is lowered to a preset height.

### CROSS-REFERENCE TO RELATED APPLICATIONS

This application is a national stage entry under 35 U.S.C. § 371 of International Application No. PCT/CN2024/072385, filed Jan. 15, 2024, which claims priority to Chinese Patent Application No. 202310097556.6 filed Jan. 19, 2023, Chinese Patent Application No. 202320181626.1 filed Jan. 19, 2023, Chinese Patent Application No. 202320397956.4 filed Mar. 3, 2023, Chinese Patent Application No. 202322000066.8 filed Jul. 27, 2023, and Chinese Patent Application No. 202322779739.4 filed on Oct. 17, 2023. The entire disclosures of the above-identified applications are hereby incorporated herein by reference.

### FIELD

The present disclosure relates to the field of warehousing and logistics technology, and more particularly, to a handling robot and an assistive device.

### BACKGROUND

At present, in the field of logistics and warehousing, a handling robot is usually used to carry out handling operations. For example, in a case where goods are delivered from a warehouse, the handling robot needs to take target goods off a shelf and transport the target goods to a delivery position. Compared with manual handling, the handling robot improves the warehousing and ex-warehousing efficiency, and saves a large amount of human resources. The handling robot may have various types of structures, among which a handling robot having a scissor-type lifting mechanism is particularly common. The scissor-type lifting mechanism occupies less space in a folded state, and can achieve a larger lifting stroke. In the field of logistics and warehousing, use of the scissor-type lifting robot to perform the handing operation may effectively improve the efficiencies of warehousing, ex-warehousing and picking operations.

### SUMMARY

According to embodiments of the present disclosure, there is provided a handling robot, including: a chassis assembly, configured to be supported on a working surface; a tray assembly, disposed above the chassis assembly and configured to bear a container; a scissor lift assembly, disposed between the chassis assembly and the tray assembly and configured to drive the tray assembly up or down relative to the chassis assembly; and a supporting part, configured to support the tray assembly in a case where the tray assembly is lowered to a preset height.

According to embodiments of the present disclosure, there is provided a handling robot, including: a chassis assembly, configured to be supported on a working surface; a tray assembly, disposed above the chassis assembly and configured to bear a container; a scissor lift assembly, disposed between the chassis assembly and the tray assembly, and configured to drive the tray assembly up or down relative to the chassis assembly; and a driving device, configured to drive movement of the scissor lift assembly to drive the tray assembly up or down relative to the chassis assembly. The driving device is disposed on scissor lift assembly.

### BRIEF DESCRIPTION OF THE DRAWINGS

FIG. 1 is a schematic structural diagram illustrating a handling robot provided by the present disclosure in Embodiment 1;

FIG. 2 is a schematic structural diagram illustrating a chassis assembly provided by the present disclosure in Embodiment 1;

FIG. 3 is a schematic structural diagram illustrating a handling robot at another angle provided by the present disclosure in Embodiment 1;

FIG. 4 is a schematic structural diagram illustrating a scissor lift assembly provided by the present disclosure in Embodiment 1;

FIG. 5 is a schematic structural diagram illustrating a scissor lift assembly provided by the present disclosure in Embodiment 2;

FIG. 6 is a schematic diagram of FIG. 5 at another angle;

FIG. 7 is a schematic structural diagram illustrating a handling robot of the present disclosure at a lifting position;

FIG. 8 is a schematic structural diagram illustrating a handling robot of the present disclosure at an initial position;

FIG. 9 is a schematic structural diagram illustrating a scissor lift assembly of the present disclosure at a lifting position;

FIG. 10 is a schematic structural diagram illustrating a handling robot of the present disclosure at an initial position with hidden comb teeth;

FIG. 11 is a partial enlarged view of a tray assembly of the present disclosure at a position of through hole;

FIG. 12 is a schematic structural diagram illustrating a first type of assistive assembly of the present disclosure;

FIG. 13 is a cross-sectional view of a first type of assistive assembly of the present disclosure;

FIG. 14 is a schematic structural diagram illustrating a second type of assistive assembly of the present disclosure;

FIG. 15 is a cross-sectional view of a second type of assistive assembly of the present disclosure;

FIG. 16 is a schematic structural diagram illustrating a first chassis and a second chassis of the present disclosure;

FIG. 17 is a cross-sectional view illustrating of a third type of assistive assembly of the present disclosure;

FIG. 18 is a schematic structural diagram illustrating a handling robot at an initial position in an embodiment of the present disclosure;

FIG. 19 is an explosive diagram illustrating a handling robot in an embodiment of the present disclosure;

FIG. 20 is a schematic structural diagram illustrating a handling robot with a part of the comb teeth hidden in an embodiment of the present disclosure;

FIG. 21 is a schematic diagram illustrating an overall structure of a handling robot according to an embodiment of the present disclosure;

FIG. 22 is a schematic structural diagram illustrating a scissor lift assembly and a driving assembly according to an embodiment of the present disclosure;

FIG. 23 is a schematic diagram illustrating an overall structure of a handling robot according to an embodiment of the present disclosure; and

FIG. 24 is a schematic diagram illustrating an overall structure of a chassis assembly according to an embodiment of the present disclosure.

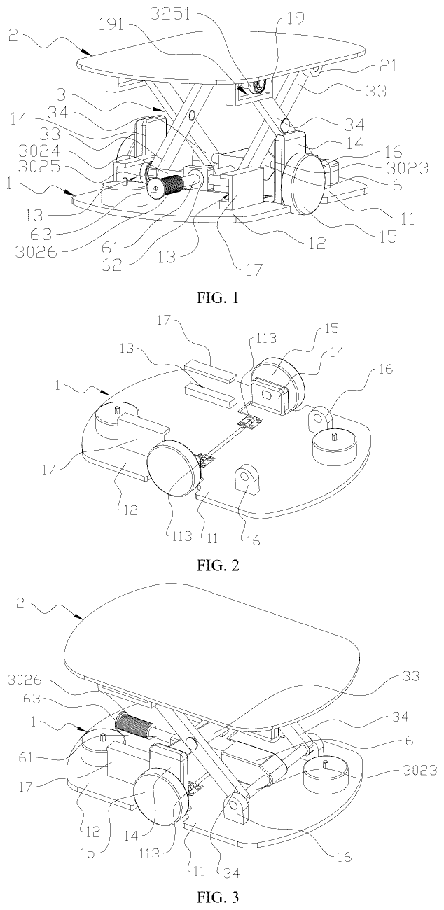

The one-to-one correspondence between component names and reference numerals in FIG. 1 to FIG. 24 is as follows:
1. chassis assembly; 11. first chassis; 113. hinge; 12. second chassis; 13. first guiding groove; 14. supporting assembly; 15. driving wheel; 16. first bracket; 161. hinge hole; 17. first guiding block; 18. omnidirectional wheel; 19. second guiding block; 191. second guiding groove; 140. second bracket; 170. travel driving device; 2. tray assembly; 21. third bracket; 22. fourth bracket; 210. through opening; 220. through hole; 23. rolling part; 24. comb teeth; 25. baffle; 26. tray body; 3. scissor lift assembly; 31. fourth scissor arm; 32. third scissor arm; 33. second scissor arm; 34. first scissor arm; 35. driving mechanism; 310. first connecting rod assembly; 311. first connecting rod; 312. second connecting rod; 320. second connecting rod assembly; 321. third connecting rod; 322. fourth connecting rod; 330. linkage rod; 331. first linkage rod; 332. second linkage rod; 301. first rotation shaft; 302. second rotation shaft; 303. third rotation shaft; 304. fourth rotation shaft; 305. fifth rotation shaft; 306. sixth rotation shaft; 307. seventh rotation shaft; 3023. first rotating shaft; 3231. third rotating shaft; 3024. second rotating shaft; 3241. fourth rotating shaft; 3025. first roller; 3251. second roller; 3026. elastic device; 3029. fifth rotating shaft; 3030. sixth rotating shaft; 4. assistive assembly; 41. fixing base; 42. guiding rod; 421. limiting member; 43. movable part; 44. energy storage member; 45. fixing sleeve; 451. sealing member; 46. bullseye bearing; 461. bearing body; 462. abutment member; 47. sliding rod; 471. protrusion; 5. movable platform; 6. driving device; 61. roller screw; 62. screw nut; 63. stopping part.

### DETAILED DESCRIPTION

Various example embodiments of the present disclosure will be described in detail below with reference to the accompanying drawings. It should be noted that the relative arrangement of components and steps, numeric expressions, and numerical values set forth in these embodiments do not limit the scope of the present disclosure unless specifically stated otherwise.

The following description of at least one example embodiment is explanatory and is in no way intended to limit the present disclosure and its application or use.

Techniques, methods, and devices known to those skilled in the relevant art may not be discussed in detail, but should be regarded as a part of the specification where appropriate.

In examples shown and discussed herein, any specific values should be construed as explanatory and not as restrictive. Accordingly, other examples of example embodiments may have different values.

It should be noted that like reference numerals and letters refer to similar items in the following drawings, and therefore, once an item is defined in a drawing, it is not necessary to further discuss it in the following drawings.

Herein, terms such as “upper”, “lower”, “front”, “rear”, “left”, “right” or the like are used to describe a relative positional relationship between related parts, and do not define the absolute positions of these related parts.

Herein, terms such as “first”, “second” or the like are used to distinguish from each other, and do not indicate a degree of importance, an order, a prerequisite for the existence of each other, or the like.

Herein, terms such as “equal” and “identical” are not strictly mathematical and/or geometric limitations, but also include errors that may be understood by those skilled in the art and are allowed in manufacture or use, and the like.

Unless otherwise indicated, numerical ranges herein include not only the entire range within two endpoints thereof, but also several sub-ranges included therein.

In order to solve the problems in the related art, the present disclosure provides a handling robot and an assistive device.

According to a first aspect of the present disclosure, there is provided a handling robot, including: a chassis assembly, configured to be supported on a working surface; a tray assembly, disposed above the chassis assembly and configured to bear a container; a scissor lift assembly, disposed between the chassis assembly and the tray assembly and configured to drive the tray assembly up or down relative to the chassis assembly; and a supporting part, configured to support the tray assembly in a case where the tray assembly is lowered to a preset height.

In an embodiment of the present disclosure, driving wheels are disposed at two opposite sides of the chassis assembly, and the supporting part is disposed at a position near the driving wheels.

In an embodiment of the present disclosure, the supporting part is disposed on the chassis assembly and is configured to extend upward such that the tray assembly is supported on the supporting part in the case where the tray assembly is lowered to the preset height; or the supporting part is disposed on the tray assembly and is configured to extend downward such that the tray assembly is supported on the chassis assembly through the supporting part in the case where the tray assembly is lowered to the preset height.

In an embodiment of the present disclosure, the supporting part is a supporting assembly or an assistive assembly.

In an embodiment of the present disclosure, the supporting part is an assistive assembly, and the assistive assembly is disposed between the chassis assembly and the tray assembly; and the tray assembly is configured to move to an initial position under control of a driving mechanism and by resisting against an elastic force of the assistive assembly, and/or is configured to move to a lifting position under control of the driving mechanism and under the elastic force of the assistive assembly.

In an embodiment of the present disclosure, the assistive assembly is configured to be pre-pressed between the tray assembly and the chassis assembly during a movement of the tray assembly relative to the chassis assembly.

In an embodiment of the present disclosure, the assistive assembly is configured to be pre-pressed between the tray assembly and the chassis assembly after the tray assembly moves a preset distance from the lifting position to the initial position; and is configured to detach from the chassis assembly or the tray assembly after the tray assembly moves a preset distance from the initial position to the lifting position.

In an embodiment of the present disclosure, the assistive assembly is configured to extend in a vertical direction and includes a connecting part and a movable part pre-pressed on the connecting part; the connecting part is secured to the chassis assembly, and the movable part is configured for fitting with the tray assembly; or the connecting part is secured to the tray assembly, and the movable part is configured for fitting with the chassis assembly.

In an embodiment of the present disclosure, a rolling part is disposed between the chassis assembly and the movable part, and the chassis assembly is configured to rollably fit with the movable part through the rolling part; and the rolling part is configured to roll between the chassis assembly and the movable part in a case where the tray assembly rocks relative to the chassis assembly, or a rolling part is disposed between the tray assembly and the movable part, and the tray assembly is configured to rollably fit with the movable part through the rolling part; and the rolling part is configured to roll between the tray assembly and the movable part in a case where the tray assembly rocks relative to the chassis assembly.

In an embodiment of the present disclosure, the rolling part is a rolling shaft, and a rotating shaft of the rolling shaft is perpendicular or parallel to a traveling direction of the handling robot.

In an embodiment of the present disclosure, the movable part of the assistive assembly has a curved surface, and the curved surface of the movable part is configured to abut against the chassis assembly or the tray assembly.

In an embodiment of the present disclosure, the connecting part includes a fixing base and a guiding rod extending from the fixing base in a vertical direction; the movable part is sleeved on the guiding rod; an energy storage member is disposed between the fixing base and the movable part, and the energy storage member is configured to make the movable part have a tendency to move away from the fixing base to provide a vertically upward elastic force to the tray assembly.

In an embodiment of the present disclosure, a through hole is disposed at an abutment position of the tray assembly or the chassis assembly; and the through hole is configured to have a diameter greater than a diameter of the guiding rod and less than a diameter of the movable part.

In an embodiment of the present disclosure, the connecting part includes a fixing sleeve, and the movable part is configured to be movably connected within the fixing sleeve; and an energy storage member is disposed between the fixing sleeve and the movable part, and is configured to make the movable part have a tendency to move outward to provide a vertically upward elastic force to the tray assembly.

In an embodiment of the present disclosure, the movable part includes a sliding rod and a bullseye bearing; the sliding rod is configured to be slidably connected within the fixing sleeve and is configured to have a tendency to move outward under an action of the energy storage member; and the bullseye bearing is configured to be detachably connected to a top end of the sliding rod and is configured to abut against the chassis assembly or the tray assembly.

In an embodiment of the present disclosure, the energy storage member is a spring-type, gas-type, or hydraulic type energy storage member.

In an embodiment of the present disclosure, at least two assistive assemblies are provided, and the at least two assistive assemblies are disposed at two opposite sides of the chassis assembly and are configured to fit with two corresponding sides of the tray assembly; or the at least two assistive assemblies are disposed at two opposite sides of the tray assembly and are configured to fit with two corresponding sides of the chassis assembly.

In an embodiment of the present disclosure, the handling robot satisfies:
Fp≥G1+G2−F, where F≤G1,
where G1 represents a force downward caused by gravity of the tray assembly in an unloaded state, G2 represents a maximum container weight bearable by the tray assembly; F represents a maximum elastic force of the assistive assembly in a case where the tray assembly is at the initial position, and Fp represents a peak driving force provided by the driving mechanism.

In an embodiment of the present disclosure, the handling robot satisfies:
Fp≥G1+G2−F, where G1<F<G1+G2/2;
Fp≥G2/2, where F=G1+G2/2;
Fp≥F−G, where F>G1+G2/2.

In an embodiment of the present disclosure, the chassis assembly includes a first chassis and a second chassis hinged to the first chassis; and the first chassis and the second chassis are configured to be co-supported on the working surface, and the scissor lift assembly includes at least a first scissor arm and a second scissor arm hinged together; a bottom of one of the first scissor arm and second scissor arm is connected to a position on the first chassis away from the second chassis; and a bottom of the other one of the first scissor arm and second scissor arm is connected to a position on the second chassis away from the first chassis.

In an embodiment of the present disclosure, the supporting part is a supporting assembly disposed on the first chassis and protruded from an end surface of the first chassis; and the tray assembly is configured to be supported on the supporting assembly in a case where the tray assembly is lowered to the preset height.

In an embodiment of the present disclosure, driving wheels are disposed at two opposite sides of the chassis assembly, and the supporting assembly is configured to extend upward beyond the driving wheel.

In an embodiment of the present disclosure, the supporting assembly is disposed at a position on the first chassis near the driving wheel.

In an embodiment of the present disclosure, the supporting part is an assistive assembly, the tray assembly is configured to apply a positive pressure to such a position of the chassis assembly that corresponds to a driving wheel through the assistive assembly; the driving wheel is disposed on the first chassis, and the assistive assembly is disposed at such a position of the first chassis, the second chassis or the tray assembly that is near the driving wheel.

In an embodiment of the present disclosure, the scissor lift assembly includes a driving device disposed between the first scissor arm and the second scissor arm, and the driving device is configured to drive the second scissor arm to rotate relative to the first scissor arm.

In an embodiment of the present disclosure, at least two first scissor arms and at least two second scissor arms are provided, the at least two first scissor arms are connected at the bottom through a first rotating shaft, the at least two second scissor arms are connected at the bottom through a second rotating shaft; and the driving device is disposed between the first rotating shaft and the second rotating shaft, and is configured to drive the first rotating shaft and the second rotating shaft to move away from or close to each other.

In an embodiment of the present disclosure, the first rotating shaft is hinged to a first bracket located on an end surface of the first chassis; and the second rotating shaft is guidably fitted with the second chassis and is configured to move along the second chassis under drive of the driving device; or the first rotating shaft is hinged to a first bracket located on an end surface of the second chassis; and the second rotating shaft is guidably fitted with the first chassis and is configured to move along the first chassis under drive of the driving device.

In an embodiment of the present disclosure, first rollers are disposed at opposite ends of the second rotating shaft; a first guiding block is disposed on the first chassis or the second chassis, and the first guiding block has a first guiding groove for guidably fitting with the first roller, or first guiding blocks are disposed at opposite ends of the second rotating shaft, and the first guiding block has a first guiding groove; and the first chassis or the second chassis is provided with a first roller for fitting with the first guiding groove.

In an embodiment of the present disclosure, the at least two first scissor arms are connected at top through a third rotating shaft, and the at least two second scissor arms are connected at top through a fourth rotating shaft; one of the third rotating shaft and the fourth rotating shaft is hinged to a third bracket located on an end surface of the tray assembly; second rollers are disposed at two opposite ends of the other one of the third rotating shaft and the fourth rotating shaft; a second guiding block is disposed on the tray assembly, and the second guiding block has a second guiding groove for guidably fitting with the second rollers; or second guiding blocks are disposed at two opposite ends of the other one of the third rotating shaft and the fourth rotating shaft, the second guiding blocks have second guiding grooves; and the tray assembly is provided with second rollers for guidably fitting with the second guiding grooves.

In an embodiment of the present disclosure, a body of the driving device is sleeved on the first rotating shaft and is configured to rotate relative to the first rotating shaft; and an output end of the driving device is connected to the second rotating shaft.

In an embodiment of the present disclosure, an elastic device is disposed between the second rotating shaft and the output end of the driving device, and the elastic device is configured to make the second rotating shaft have a tendency to move towards the first rotating shaft.

In an embodiment of the present disclosure, the output end of the driving device is a roller screw, and a screw nut engaged with the roller screw is disposed on the second rotating shaft; a stopping part is disposed at an end of the roller screw passing through the screw nut; and the elastic device is disposed between the stopping part and the screw nut.

In an embodiment of the present disclosure, the elastic device is configured to be pre-pressed between the stopping part and the screw nut during a movement of the screw nut relative to the stopping part.

In an embodiment of the present disclosure, the elastic device is configured to be pre-pressed between the stopping part and the screw nut after the stopping part and the screw nut move toward each other by a preset distance; or configured to detach from the stopping part and/or the screw nut after the stopping part and the screw nut move away from each other by a preset distance.

In an embodiment of the present disclosure, the scissor lift assembly includes at least a third scissor arm and a fourth scissor arm hinged together; the third scissor arm is hinged to the first scissor arm through a fifth rotating shaft; the fourth scissor arm is hinged to the second scissor arm through a sixth rotating shaft; the scissor lift assembly further includes a driving device disposed between the fifth rotating shaft and the sixth rotating shaft, and the driving device is configured to drive the fifth rotating shaft and the sixth rotating shaft to move away from or close to each other.

In an embodiment of the present disclosure, the chassis assembly includes a first chassis and a second chassis hinged to the first chassis; and the first chassis and the second chassis are configured to be co-supported on the working surface; the handling robot further includes a movable platform, a first side of the movable platform is hinged to the second chassis, and a second side of the movable platform is movably connected to the first chassis; and the scissor lift assembly is disposed between the movable platform and the tray assembly and is configured to drive the tray assembly up or down relative to the chassis assembly.

In an embodiment of the present disclosure, the scissor lift assembly includes at least a first scissor arm and a second scissor arm hinged together; a bottom of one of the first scissor arm and the second scissor arm is hinged to the first side of the movable platform, and a bottom of the other one of the first scissor arm and the second scissor arm is slidably connected to the second side of the movable platform.

In an embodiment of the present disclosure, the tray assembly includes a tray body and at least two comb teeth disposed on the tray body at intervals; the tray body and a bottom of the comb teeth define a space for accommodating the scissor lift assembly; and a top of the scissor lift assembly is configured to penetrate the tray body and is configured to be connected to a sidewall of the comb teeth.

In an embodiment of the present disclosure, the supporting part is disposed on the movable platform or at a position on the tray assembly near a driving wheel, and the tray assembly is configured to apply a positive pressure to such a position of the chassis assembly that corresponds to the driving wheel through the supporting part and the movable platform.

In an embodiment of the present disclosure, the supporting part is disposed at such a position of the first chassis, the second chassis or the tray assembly that is near the driving wheel, and is configured to penetrate the movable platform.

According to a second aspect of the present disclosure, there is provided a handling robot, including: a chassis assembly, configured to be supported on a working surface, in which the chassis assembly includes a first chassis and a second chassis hinged to the first chassis; and the first chassis and the second chassis are configured to be co-supported on the working surface, a tray assembly, disposed above the chassis assembly and configured to bear a container, a scissor lift assembly, configured to be controlled by a driving mechanism to drive the tray assembly to move between an initial position and a lifting position in a height direction, and a movable platform, in which a first side of the movable platform is hinged to the second chassis and a second side of the movable platform is movably connected to the first chassis; and the scissor lift assembly is disposed between the movable platform and the tray assembly and is configured to drive the tray assembly up or down relative to the chassis assembly.

In an embodiment of the present disclosure, the handling robot further includes a supporting part, the supporting part is disposed on the chassis assembly and is configured to extend upward such that the tray assembly is supported on the supporting part in a case where the tray assembly is lowered to a preset height; or the supporting part is disposed on the tray assembly and is configured to extend downward such that the tray assembly is supported on the chassis assembly through the supporting part in a case where the tray assembly is lowered to a preset height.

According to a third aspect of the present disclosure, there is provided an assistive device, including: a connecting part; and a movable part configured to be pre-pressed on the connecting part through an energy storage member. The movable part includes a sliding rod and a bullseye bearing; the sliding rod is slidably connected to the connecting part, and the bullseye bearing is detachably connected to a free end of the sliding rod.

In an embodiment of the present disclosure, the connecting part includes a fixing base and a fixing sleeve, the fixing sleeve is screwed to the fixing base; the sliding rod is slidably connected within the fixing sleeve and is configured to have a tendency to move outward under an action of the energy storage member; and a bottom end of the sliding rod is configured as a protrusion, and a sealing member is disposed at a position of an upper opening of the fixing sleeve and configured to abut against and fit with the protrusion in a case where the sliding rod moves to a highest position.

In an embodiment of the present disclosure, the bullseye bearing includes a bearing body and an abutment member, the bearing body is detachably connected to a top end of the sliding rod through thread; the abutment member is squeezed between the bearing body and the sliding rod; and the energy storage member is configured to be pre-pressed between a lower end surface of the abutment member and an upper end surface of the fixing base.

According to a fourth aspect of the present disclosure, there is provided a handling robot, including: a chassis assembly, configured to be supported on a working surface; a tray assembly, disposed above the chassis assembly; and a scissor lift assembly. The scissor lift assembly includes at least a first connecting rod assembly, a second connecting rod assembly, and at least two linkage rods, the first connecting rod assembly and the second connecting rod assembly are hinged between the chassis assembly and the tray assembly and are interlaced with each other, the at least two linkage rods are hinged to the first connecting rod assembly and the second connecting rod assembly to form a quadrilateral structure, and the tray assembly is configured to move relative to the chassis assembly in a height direction under a limitation of the quadrilateral structure.

In an embodiment of the present disclosure, the first connecting rod assembly includes a first connecting rod and a second connecting rod which are connected through a first rotation shaft, the first connecting rod is hinged to the tray assembly, and the second connecting rod is hinged to the chassis assembly; the second connecting rod assembly includes a third connecting rod and a fourth connecting rod which are connected through a second rotation shaft, the third connecting rod is hinged to the tray assembly, and the fourth connecting rod is hinged to the chassis assembly; and the first connecting rod and the third connecting rod are interlaced with each other, and the second connecting rod and the fourth connecting rod are interlaced with each other.

In an embodiment of the present disclosure, the first connecting rod, the fourth connecting rod, and the at least two linkage rods form the quadrilateral structure; or the second connecting rod, the third connecting rod, and the at least two linkage rods form the quadrilateral structure.

In an embodiment of the present disclosure, a connection between the first connecting rod assembly and the tray assembly is spaced apart from a connection between the second connecting rod assembly and the tray assembly; and a connection between the first connecting rod assembly and the chassis assembly is spaced apart from a connection between the second connecting rod assembly and the chassis assembly.

In an embodiment of the present disclosure, the linkage rod include a first linkage rod and a second linkage rod; a first end of the first linkage rod is hinged to the first connecting rod, and a second end of the first linkage rod is hinged to the second rotation shaft; and a first end of the second linkage rod is hinged to the fourth connecting rod, and a second end of the second linkage rod is hinged to the first rotation shaft.

In an embodiment of the present disclosure, the first end of the first linkage rod is hinged between two ends of the first connecting rod, and the second linkage rod is hinged between two ends of the fourth connecting rod.

In an embodiment of the present disclosure, the quadrilateral structure is a parallelogram.

In an embodiment of the present disclosure, the first connecting rod assembly, the second connecting rod assembly and the at least two linkage rods forming a same quadrilateral structure are configured as a connecting rod unit, at least two connecting rod units are disposed between the chassis assembly and the tray assembly, and the at least two connecting rod units are connected through a connecting shaft and move synchronously.

In an embodiment of the present disclosure, a first bracket and a second bracket are disposed on the chassis assembly, the first connecting rod assembly is connected to the first bracket through a third rotation shaft, and the second connecting rod assembly is connected to the second bracket through a fourth rotation shaft; a third bracket and a fourth bracket are disposed on the tray assembly, the first connecting rod assembly is connected to the third bracket through a fifth rotation shaft, and the second connecting rod assembly is connected to the fourth bracket through a sixth rotation shaft.

In an embodiment of the present disclosure, a driving assembly is further included, the driving assembly is disposed on the chassis assembly or the tray assembly, and the driving assembly is configured to: drive the first connecting rod assembly to rotate relative to the chassis assembly or the tray assembly, or drive the second connecting rod assembly to rotate relative to the chassis assembly or the tray assembly.

In an embodiment of the present disclosure, the driving assembly includes a first driving rod and a second driving rod that are hinged, and a rotating motor fixed on the chassis assembly or the tray assembly, the second driving rod is hinged to the first connecting rod assembly or the second connecting rod assembly, and the rotating motor is configured to drive the first driving rod to rotate, and drive the first connecting rod assembly or the second connecting rod assembly to rotate through the second driving rod.

In an embodiment of the present disclosure, the driving assembly includes a linear driver, a body of the linear driver is hinged to the chassis assembly or the tray assembly, and an output end of the linear driver is hinged to the first connecting rod assembly or the second connecting rod assembly.

In an embodiment of the present disclosure, the chassis assembly includes a first chassis and a second chassis hinged to the first chassis, the first connecting rod assembly is hinged to the first chassis, and the second connecting rod assembly is hinged to the second chassis.

In an embodiment of the present disclosure, the driving assembly is disposed on the first chassis and is configured to drive the second connecting rod assembly to rotate relative to the second chassis; and/or the driving assembly is disposed on the second chassis and is configured to drive the first connecting rod assembly to rotate relative to the first chassis.

In some embodiments, there is provided a handling robot, including: a chassis assembly, configured to be supported on a working surface; a tray assembly, disposed above the chassis assembly and configured to bear a container; a scissor lift assembly, disposed between the chassis assembly and the tray assembly, and configured to drive the tray assembly up or down relative to the chassis assembly; and a driving device, configured to drive movement of the scissor lift assembly to drive the tray assembly up or down relative to the chassis assembly. The driving device is disposed on scissor lift assembly.

In some embodiments, the scissor lift assembly includes two scissor arms hinged together, the driving device is configured to drive one of the two scissor arms to rotate relative to the other one of the two scissor arms to make the two scissor arms close to or away from each other at top and bottom to increase or decrease a size of the scissor lift assembly in a height direction.

In some embodiments, the driving device is connected to the two scissor arms to drive one of the two scissor arms to rotate relative to the other one of the two scissor arms; the scissor lift assembly includes a rotating shaft and at least two pairs of scissor arms, each pair of scissor arms include the two scissor arms, and one of the two pairs of scissor arms is connected with the other one of the two pairs of scissor arms by the rotating shaft; and the driving device is connected to the rotating shaft to drive rotation of the rotating shaft to drive movement of the scissor arms.

Beneficial effects of the present disclosure are that the supporting part is provided, and the tray assembly is supported on the supporting part in a case where the tray assembly is lowered to the preset height, so that a part of the weight of the tray assembly and the goods thereon is shared to the supporting part, rather than the entire weight being pressed on the scissor lift assembly, which reduces the pressure on the scissor lift assembly and prolongs the life of the scissor lift assembly. Furthermore, since the supporting part bears a part of the weight, the driving force required at the initial stage of upward lifting is small, thereby reducing the requirement for the power of the driving mechanism.

The present disclosure provides a handling robot, which may be a handling robot used in a warehousing field, by which a target container in a warehousing area may be transferred, for example, between different vehicles, between different storage sites of the same vehicle, or between a vehicle and other positions. Of course, the handling robot of the present disclosure may also be used in other application scenarios, such as shopping malls, hotels, workshops and other scenarios well-known to those skilled in the art where handling and transfer are needed, which will not be elaborated in the present disclosure here.

The handling robot includes a chassis assembly, a tray assembly, a scissor lift assembly, and a supporting part, and the chassis assembly is configured to be supported on a working surface. The chassis assembly may also drive the handling robot to travel on the working surface. The chassis assembly may be provided with a driving wheel and/or an omnidirectional wheel cooperated with the driving wheel, and the driving wheel and the omnidirectional wheel are cooperated to together drive the handling robot to travel and turn on the working surface to facilitate the handling robot to transfer a container.

The tray assembly is disposed above the chassis assembly and configured to bear a container. The container may be a container used for loading goods or commodities in the field of logistics and warehousing, including but not limited to bins, cargo boxes, packing boxes, or the like, and the present disclosure does not limit a type and a shape of the container. The scissor lift assembly is disposed between the chassis assembly and the tray assembly and configured to drive the tray assembly up or down relative to the chassis assembly to lift or lower the container on the tray assembly.

In a case, the tray assembly may be in a low position for a long time, and the entire weight of the tray assembly and the container will be applied to the scissor lift assembly and the chassis assembly. A large driving force is required to lift the tray assembly upward from the low position, because an included angle between scissor arms is very small at the low position, and a large lifting driving force is required to drive the scissor lift assembly to start moving toward a lifting position. In order to prevent the scissor lift assembly from bearing the entire weight of the tray assembly and the container, the weight of the tray assembly and the container needs to be dispersed. For this, the handling robot according to the present disclosure is provided with a supporting part, and the tray assembly is configured to be supported on the supporting part when the tray assembly is lowered to a preset height.

In the present disclosure, by providing the supporting part to allow the tray assembly to be supported on the supporting part when the tray assembly is lowered to the preset height, a part of the weight of the tray assembly and the goods thereon is shared to the supporting part, rather than the entire weight being pressed on the scissor lift assembly, which reduces the pressure on the scissor lift assembly and prolongs the life of the scissor lift assembly. Furthermore, since the supporting part bears a part of the weight, the driving force required at the initial stage of upward lifting is small, thereby reducing the requirement for the power of the driving mechanism.

In an embodiment of the present disclosure, driving wheels are disposed at two opposite sides of the chassis assembly, and the supporting part is disposed at a position near the driving wheel. The handling robot is able to travel on the ground by at least two driving wheels disposed at the opposite sides of the chassis assembly. When transporting the container, a center of gravity of the handling robot may shift, resulting in an unstable traveling process. For this, in an embodiment, the supporting part is disposed at the position near the driving wheel, and the tray assembly may apply a positive pressure to such a position of the chassis assembly that corresponds to the driving wheel through the supporting part, to make the driving wheel adhere to the ground more tightly, so that the handling robot can travel more smoothly.

In an embodiment of the present disclosure, the supporting part is disposed on the chassis assembly and is configured to extend upward such that the tray assembly is supported on the supporting part when the tray assembly is lowered to the preset height; or the supporting part is disposed on the tray assembly and is configured to extend downward such that the tray assembly is supported on the chassis assembly through the supporting part when the tray assembly is lowered to the preset height. The supporting part may be mounted on an upper surface of the chassis assembly to support the tray assembly upwardly. The supporting part may also be mounted on a lower surface of the tray assembly and extend downward to abut against the upper surface of the chassis assembly in a descending process.

In an embodiment, in order to carry a container with a larger volume, a bearing area of the tray assembly may be larger than an area of the chassis assembly. In a case where a length of the supporting part extending upward does not exceed a height of the driving wheel, the tray assembly will first abut against the driving wheel in the descending process and cannot be supported on the supporting part. For this, an abutment structure extending opposite to the supporting part may be disposed at a side where the supporting part is not disposed. In a case where the supporting part is disposed on the chassis assembly, the abutment structure is disposed on the lower surface of the tray assembly; in a case where the supporting part is disposed on the tray assembly, the abutment structure is disposed on the upper surface of the chassis assembly. The abutment structure may be disposed at a position corresponding to the supporting part, thereby ensuring that the tray assembly may be supported on the supporting part without in contact with the driving wheel. In an embodiment, the length of the supporting part extending upward may be further defined. In a case where the supporting part is disposed on the chassis assembly, the supporting part extends upward to a height exceeding the driving wheel. In a case where the supporting part is disposed on the tray assembly, a length of the supporting part extending downward is configured to be greater than a length of a part of the driving wheel above the chassis assembly, thereby ensuring that a bottom surface of the tray assembly may be directly supported on the supporting part when the tray assembly is lowered to the preset height.

In an embodiment of the present disclosure, the supporting part is a supporting assembly or an assistive assembly. The supporting assembly may be a rigid supporting block, and the assistive assembly may be an elastic assistive device. The rigid supporting assembly may realize the basic function of the supporting part, while the elastic assistive assembly may also play an assistive role on the basis of weight dispersion. In an embodiment, the assistive assembly may be provided with an elastic device capable of storing energy. When the tray assembly moves downward to be supported on the assistive assembly, the elastic device is compressed to store energy. The stored energy may be released in a next upward movement of the tray assembly, and the assistive assembly provides an upward elastic force for the tray assembly, thereby reducing a lifting force and a driving force required for the scissor lift assembly to lift upward, and reducing the requirement for the power of the driving mechanism.

### First Embodiment

Referring to FIG. 1 and FIG. 2, a handling robot of the present disclosure includes a chassis assembly 1, a scissor lift assembly 3, and a tray assembly 2.

The chassis assembly 1 may support the entire handling robot on a working surface, and has a certain length and width with respect to the ground to ensure the stability of its own movement. The chassis assembly 1 may be provided with a driving wheel 15, which is in contact with the working surface and drives the chassis assembly 1 to move on the working surface.

In an example, the chassis assembly 1 includes a first chassis 11 and a second chassis 12 hinged to the first chassis 11. The first chassis 11 and the second chassis 12 are configured to be co-supported on the working surface.

For example, referring to FIG. 2, the second chassis 12 may be connected to the first chassis via a hinge 113, and the second chassis 12 is able to rotate relative to the first chassis 11 around the hinge 113. Two hinges 113 may be arranged at intervals and in parallel to ensure the stability of relative rotation between the second chassis 12 and the first chassis 11.

In a case where the handling robot works, the handling robot moves according to a preset path or a traveling direction. When the handling robot enters a working surface with a slope or crosses an obstacle, the second chassis 12 of the chassis assembly 1 will adaptively deflect relative to the first chassis 11 due to the change of the slope of the working surface. For example, referring to FIG. 1, in a case where the second chassis 12 travels to a working surface with an ascending slope, the second chassis 12 is deflected clockwise around a rotation axis relative to the first chassis 11 to adapt to the ascending slope, with a hinged position of the first chassis 11 and the second chassis 12 as the rotation axis. Similarly, in a case where the second chassis 12 travels to a working surface with a descending slope, the second chassis 12 is deflected counterclockwise around the rotation axis relative to the first chassis 11 to adapt to the descending slope. In the above cases, the second chassis 12 is adaptively deflected according to the slope of the working surface, to prevent severe jolts that would otherwise occur when directly entering a sloped working surfaces, and thus prevent the container carried by the handling robot from falling, and improve the stability of the handling robot in transferring goods.

The scissor lift assembly 3 is disposed on the chassis assembly 1 and is configured to move along an extending direction of the first chassis 11 and the second chassis 12 of the chassis assembly 1 to increase or decrease a size of the scissor lift assembly 3 in a height direction.

In an example, the scissor lift assembly 3 includes at least a first scissor arm 34 and a second scissor arm 33 hinged together, and the first scissor arm 34 and the second scissor arm 33 are close to or away from each other at the top and bottom to increase or decrease the size of the scissor lift assembly 3 in the height direction.

The bottom of one of the first scissor arm 34 and second scissor arm 33 is connected to the first chassis 11, and the bottom of the other one of the first scissor arm 34 and second scissor arm 33 is connected to the second chassis 12. For example, the bottom of the first scissor arm 34 is connected to the first chassis 11, the bottom of the second scissor arm 33 is connected to the second chassis 12, and the first scissor arm 34 and the second scissor arm 33 are close to or away from each other at the bottom in an extending direction of the first chassis 11 and the second chassis 12.

The tray assembly 2 is located at the top of the scissor lift assembly 3. That is, the top of the first scissor arm 34 and the top of the second scissor arm 33 are connected to the tray assembly 2, and the tray assembly 2 is configured to rise or fall relative to the chassis assembly 1 during the movement of the scissor lift assembly 3.

For example, in a case where the first scissor arm 34 and the second scissor arm 33 are close to each other at the top and bottom, the size of the scissor lift assembly 3 in the height direction increases. Since the chassis assembly 1 is always in contact with the working surface, the tray assembly 2 will be driven by the first scissor arm 34 and the second scissor arm 33 to rise in the height direction.

Similarly, in a case where the first scissor arm 34 and the second scissor arm 33 are away from each other at the top and bottom, the size of the scissor lift assembly 3 in the height direction decreases, and the tray assembly 2 will be driven by the first scissor arm 34 and the second scissor arm 33 to lower in the height direction. The tray assembly 2 may be configured to: bear the container or vehicle, move to a preset position by cooperating with the chassis assembly 1, cooperate with the scissor lift assembly 3 to perform the lifting action, and lift the container or the vehicle to store it to or take it out of a corresponding storage site. Compared with a complex lifting structure in the related art, the scissor lift assembly in the present disclosure has a simple structure, is convenient for installation and maintenance, and reduces the cost.

Referring to FIG. 3, in an embodiment of the present disclosure, the scissor lift assembly 3 includes a driving device 6 disposed between the first scissor arm 34 and the second scissor arm 33, and the driving device 6 is configured to drive the second scissor arm 33 to rotate relative to the first scissor arm 34.

For example, referring to a view direction, with a hinge point of the first scissor arm 34 and the second scissor arm 33 as a center of rotation, in a case where the driving device 6 drives the second scissor arm 33 to rotate clockwise around the center of rotation relative to the first scissor arm 34, the size of the scissor lift assembly 3 in the height direction decreases. Since the chassis assembly 1 is always in contact with the working surface, the tray assembly 2 will move toward a direction close to the chassis assembly 1 under drive of the scissor lift assembly 3, such that the tray assembly 2 is lowered in height relative to the working surface.

Similarly, in a case where the driving device 6 drives the second scissor arm 33 to move counterclockwise around the center of rotation relative to the first scissor arm 34, the size of the scissor lift assembly 3 in the height direction increases, and the tray assembly 2 will move away from the chassis assembly 1 under the drive of the scissor lift assembly 3, such that the tray assembly 2 raises in height relative to the working surface.

The driving device 6 is disposed between the first scissor arm 34 and the second scissor arm 33 to make the structure more compact, and there is no need to leave a space for installing the driving device at an outer side of the first scissor arm 34 and the second scissor arm 33, thereby improving the utilization rate of an internal space of the handling robot, and other components may be flexibly installed in the saved space.

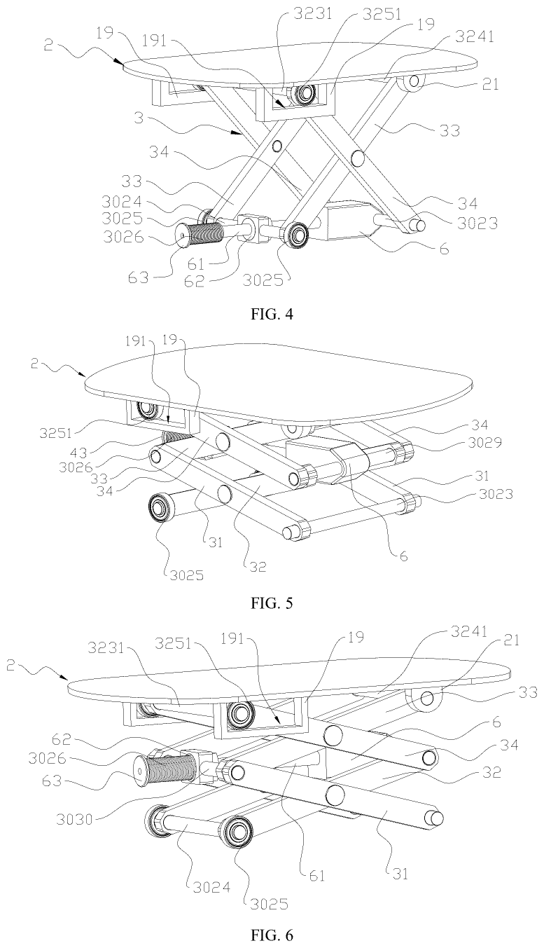

Referring to FIG. 1 and FIG. 4, in an embodiment of the present disclosure, two first scissor arms 34 and two second scissor arms 33 are provided.

For example, two first scissor arms 34 and two second scissor arms 33 are disposed on the chassis assembly 1 at intervals and in parallel. The first scissor arm 34 and the second scissor arm 33 are hinged together. That is, two sets of first scissor arm 34 and second scissor arm 33 hinged together are provided, which have the same movement relationship and function as those of the first scissor arm 34 and the second scissor arm 33 described in the previous example, which will not be elaborated here.

Referring to FIG. 1 and FIG. 3, in an embodiment, at least two first scissor arms 34 are connected at the bottom through a first rotating shaft 3023, through which the bottom of the at least two first scissor arms 34 may move synchronously. At least two second scissor arms 33 are connected at the bottom through a second rotating shaft 3024. Similarly, the bottom of the at least two second scissor arms 33 may move synchronously through the second rotating shaft 3024. The driving device 6 is disposed between the first rotating shaft 3023 and the second rotating shaft 3024, and is configured to drive the first rotating shaft 3023 and the second rotating shaft 3024 to move away from or close to each other.

For example, in a case where an output end of the driving device 6 drives the first rotating shaft 3023 and the second rotating shaft 3024 to move away from each other, the bottom of the two first scissor arms 34 connected to the first rotating shaft 3023 and the bottom of the two second scissor arms 33 connected to the second rotating shaft 3024 will synchronously move away from each other, such that the size of the scissor lift assembly 3 in the height direction decreases, and the tray assembly moves in a downward direction.

In a case where the output end of the driving device 6 drives the first rotating shaft 3023 and the second rotating shaft 3024 to move close to each other, the bottom of the two first scissor arms 34 connected to the first rotating shaft 3023 and the bottom of the two second scissor arms 33 connected to the second rotating shaft 3024 will synchronously move close to each other, such that the size of the scissor lift assembly 3 in the height direction increases and the tray assembly moves in an upward direction.

Since the scissor lift assembly 3 is provided with two first scissor arms 34 and two second scissor arms 33, the two first scissor arms 34 and two second scissor arms 33 may co-share the pressure at the top and bottom, thereby increasing the bearing capacity of the scissor lift assembly 3.

Although explanations and illustrations are made above with reference to examples where two first scissor arms 34 are cooperated with the first rotating shaft 3023, and two second scissor arms 33 are cooperated with the second rotating shaft 3024, the first rotating shaft 3023 may also be connected to more first scissor arms, and the second rotating shaft may also be connected to more second scissor arms, and each of a plurality of first scissor arms is cooperated with a respective one of a plurality of second scissor arms in pairs to co-share the pressure from the top and bottom of the scissor lift assembly 3 to improve the bearing capacity of the scissor lift assembly 3, which will not be listed one by one here.

Referring to FIG. 1 and FIG. 4, in an example of the present disclosure, the first rotating shaft 3023 is hinged to a first bracket 16 located on an end surface of the first chassis 11, and the first bracket 16 is provided with a through hole to allow the first rotating shaft 3023 to pass therethrough, and the first rotating shaft 3023 may rotate in the through hole. The second rotating shaft 3024 is guidably fitted with the second chassis 12, and is configured to move along the second chassis 12 under the drive of the driving device. The second rotating shaft 3024 may horizontally move toward or away from the first rotating shaft 3023 in the extension direction of the second chassis 12 under the drive of the driving device 6.

For example, the second rotating shaft 3024 moves away from the first rotating shaft 3023 along the extension direction of the second chassis 12 under the drive of the driving device 6, the bottom of the two second scissor arms 33 moves synchronously with the second rotating shaft 3024, and the first scissor arm 34 and the second scissor arm 33 move close to each other in the height direction, such that the size of the scissor lift assembly 3 in the height direction is reduced, and the tray assembly 2 moves close to the chassis assembly 1 under the drive of the scissor lift assembly 3.

The second rotating shaft 3024 moves close to the first rotating shaft 3023 along the extension direction of the second chassis 12 under the drive of the driving device 6, and the bottom of the two second scissor arms 33 move synchronously with the second rotating shaft 3024, the first scissor arm 34 and the second scissor arm 33 are away from each other in the height direction, such that the size of the scissor lift assembly 3 in the height direction increases, and the tray assembly 2 moves away from the chassis assembly 1 under the drive of the scissor lift assembly 3.

In an example of the present disclosure, the first rotating shaft 3023 is hinged to a first bracket 16 located on an end surface of the second chassis 12, and the first bracket is provided with a through hole to allow the first rotating shaft 3023 to pass therethrough, and the first rotating shaft 3023 may rotate in the through hole. The second rotating shaft 3024 is guidably fitted with the first chassis 11, and is configured to move along the first chassis 11 under the drive of the driving device. The second rotating shaft 3024 may horizontally move close to or away from the first rotating shaft 3023 along the extension direction of the first chassis 11 under the drive of the driving device 6.

For example, the second rotating shaft 3024 moves away from the first rotating shaft 3023 along the extension direction of the first chassis 11 under the drive of the driving device 6, the bottom of the two second scissor arms 33 moves synchronously with the second rotating shaft 3024, and the first scissor arm 34 and the second scissor arm 33 move close to each other in the height direction, such that the size of the scissor lift assembly 3 in the height direction decreases, and the tray assembly 2 moves close to the chassis assembly 1 under the drive of the scissor lift assembly 3.

The second rotating shaft 3024 moves close to the first rotating shaft 3023 along the extension direction of the first chassis 11 under the drive of the driving device 6, the bottom of the two second scissor arms 33 moves synchronously with the second rotating shaft 3024, the first scissor arm 34 and the second scissor arm 33 are away from each other in the height direction, such that the size of the scissor lift assembly 3 in the height direction increases, and the tray assembly 2 moves away from the chassis assembly 1 under the drive of the scissor lift assembly 3.

The difference from the previous examples lies in the fitting relationship of the first rotating shaft 3023 and the second rotating shaft 3024 with the first chassis and the second chassis. That is, one of the first rotating shaft 3023 and the second rotating shaft 3024 is hinged to the first chassis 11, and the other one of the first rotating shaft 3023 and the second rotating shaft 3024 is guidably fitted with the second chassis 12. With the above examples, the change of the size of the scissor lift assembly 3 in the height direction may be achieved, and the tray assembly 2 moves close to or away from the chassis assembly 1 under the drive of the scissor lift assembly 3 to realize the lifting function of the handling robot.

Referring to FIG. 1 and FIG. 4, in an example of the present disclosure, first rollers 3025 are disposed at two opposite ends of the second rotating shaft 3024; a first guiding block 17 is disposed on the first chassis 11 or the second chassis 12, and the first guiding block 17 has a first guiding groove 13 for guidably fitting with the first roller 3025. Two first guiding blocks 17 may be provided, and two first guiding grooves 13 may be defined. The two first guiding grooves 13 have the same construction, and their openings face each other.

For example, in a case where the second rotating shaft 3024 moves close to or away from the first rotating shaft 3023 under the drive of the driving device 6, the movement of the second rotating shaft 3024 may be guided by the movement of the first rollers 3025 disposed at the two opposite ends along the extension direction of the respective first guiding grooves 13. The first guiding groove 13 guides the movement of the first roller 3025, and further guides the movement of the second rotating shaft 3024 and the second scissor arm 33.

In an example of the present disclosure, first guiding blocks are disposed at two opposite ends of the second rotating shaft 3024, the first guiding block has a first guiding groove, and the first chassis 11 or the second chassis 12 is provided with a first roller for fitting with the first guiding groove. Two first rollers may be provided, and the two first rollers have the same structure and are located along the same rotation axis.

For example, in a case where the second rotating shaft 3024 moves close to or away from the first rotating shaft 3023 under the drive of the driving device 6, the movement of the second rotating shaft 3024 may be guided by the movement of the first guiding grooves disposed at the two opposite ends along the rotation direction of the respective first rollers. The first roller guides the movement of the first guiding groove, and further guides the movement of the second rotating shaft 3024 and the second scissor arm 33. The first roller and the first guiding groove may be constructed to be the same as the first roller 3025 and the first guiding groove 13 as described in the previous examples, with the same function but with different setting positions.

Referring to FIG. 1 and FIG. 4, in an example of the present disclosure, at least two first scissor arms 34 are connected at the top through a third rotating shaft 3231, and at least two second scissor arms 33 are connected at the top through a fourth rotating shaft 3241. The third rotating shaft 3231 and the fourth rotating shaft 3241 may have the same shapes as the first rotating shaft 3023 and second rotating shaft 3024.

One of the third rotating shaft 3231 and the fourth rotating shaft 3241 is hinged to a third bracket 21 located on an end surface of the tray assembly 2; second rollers 3251 are disposed at two opposite ends of the other one of the third rotating shaft 3231 and the fourth rotating shaft 3241; a second guiding block 19 is disposed on the tray assembly 2, and the second guiding block 19 has a second guiding groove 191 for guidably fitting with the second roller 3251; or second guiding blocks 19 are disposed at two opposite ends of the other one of the third rotating shaft 3231 and the fourth rotating shaft 3241, the second guiding block 19 has a second guiding groove 191; and the tray assembly 2 is provided with a second roller 3251 for fitting with the second guiding groove 191.

Referring to FIG. 4 for details, in an example of the present disclosure, the fourth rotating shaft 3241 is hinged to the third bracket 21 located on the end surface of the tray assembly 2, and the third bracket 21 is provided with a through hole to allow the fourth rotating shaft 3241 to pass therethrough, and the fourth rotating shaft 3241 may rotate in the through hole. The second rollers 3251 are disposed at the two opposite ends of the third rotating shaft 3231, the second guiding block 19 is disposed on the tray assembly 2, and the second guiding block 19 has the second guiding groove 191 for fitting with the second roller 3251. Two second guiding grooves 191 may be defined, the second guiding grooves 191 have the same construction, and their openings face each other. The shapes and sizes of the first guiding block 17 and the second guiding block 19 may be set according to the internal structure of the chassis assembly 1 and the tray assembly 2, respectively, and the shapes of the first guiding groove 13 and the second guiding groove 191 may be set reasonably according to the shapes and sizes of the respective guiding blocks, which are not limited in the present disclosure.

In an example of the present disclosure, the third rotating shaft 3231 is hinged to the third bracket 21 located on the end surface of the tray assembly 2, and the third bracket 21 is provided with a through hole to allow the third rotating shaft 3231 to pass therethrough, and the third rotating shaft 3231 may rotate in the through hole. Second rollers are disposed at the two opposite ends of the fourth rotating shaft 3241, a second guiding block is disposed on the tray assembly 2, and the second guiding block has a second guiding groove for fitting with the second rollers. Two second guiding grooves may be defined, the two guiding grooves have the same structure, and their openings face each other.

Referring to FIG. 1 and FIG. 4, in an example of the present disclosure, a body of the driving device 6 is sleeved on the first rotating shaft 3023 and is configured to be rotatable relative to the first rotating shaft 3023, and an output end of the driving device 6 is connected to the second rotating shaft 3024. In a case where the second rotating shaft 3024 moves relative to the first rotating shaft 3023, the first rotating shaft will rotate. In order to allow the driving device 6 to adapt to rotation of the first rotating shaft 3023, the body of the driving device 6 needs to be sleeved on the first rotating shaft 3023.

For example, referring to the view direction of FIG. 1, in a case where the driving device 6 drives the second rotating shaft 3024 to move away from the first rotating shaft 3023 through the output end, the first scissor arm 34 and the second scissor arm 33 move close to each other in the height direction, and the first scissor arm 34 rotates counterclockwise relative to the second scissor arm. Since two first scissor arms 34 are hinged to the first chassis 11 at the bottom through the first rotating shaft 3023, the two first scissor arms 34 will co-drive the first rotating shaft 3023 to rotate counterclockwise. Since the body of the driving device 6 is rotatably connected to the first rotating shaft 3023, and the output end of the driving device 6 does not rotate, the body of the driving device 6 remains relatively stationary at its original position.

That is, during the counterclockwise rotation of the first rotating shaft 3023 relative to the first chassis 11, the counterclockwise rotation relative to the driving device 6 will occur also, such that the driving device 6 adapts to the rotation of the first rotating shaft 3023. In a case where the driving device 6 drives the second rotating shaft 3024 to move close to the first rotating shaft 3023 through the output end, the first scissor arm 34 and the second scissor arm 33 are away from each other in the height direction, and the first scissor arm 34 rotates clockwise relative to the second scissor arm.

Since two first scissor arms 34 are hinged to the first chassis 11 at the bottom through the first rotating shaft 3023, the two first scissor arms 34 will co-drive the first rotating shaft 3023 to rotate clockwise. Since the body of the driving device 6 is rotatably connected to the first rotating shaft 3023, and the output end of the driving device 6 does not rotate, the body of the driving device 6 remains relatively stationary at its original position. That is, during the clockwise rotation of the first rotating shaft 3023 relative to the first chassis 11, the clockwise rotation relative to the driving device 6 will occur also, such that the driving device 6 adapts to the rotation of the first rotating shaft 3023.

In an example of the present disclosure, an elastic device 3026 is disposed between the second rotating shaft 3024 and the output end of the driving device 6, the elastic device 3026 may be a spring, and the elastic device 3026 is configured to make the second rotating shaft 3024 have a tendency to move towards the first rotating shaft 3023.

For example, in a case where the second rotating shaft 3024 moves away from the first rotating shaft 3023, the elastic device 3026 may be compressed to obtain elastic potential energy, such that the elastic device 3026 provides a pushing force to move the second rotating shaft 3024 towards the first rotating shaft 3023. In a case where the output end of the driving device 6 drives the second rotating shaft 3024 to move towards the first rotating shaft 3023, the elastic device 3026 releases the elastic potential energy, and assists the output end of the driving device 6 to co-drive the second rotating shaft 3024 to move towards the first rotating shaft 3023, thereby reducing the burden of the output end of the driving device 6.

It should be noted that the handling robot of the present disclosure carries the vehicle or container by lifting, and moves through the chassis assembly 1, so as to realize the transportation of the vehicle or container. When lifting the vehicle or container, the tray assembly 2 of the handling robot directly contacts with the vehicle or container, and the scissor lift assembly 3 drives the tray assembly 2 to raise to take the vehicle or container out from the storage site, so the scissor lift assembly 3 needs to overcome the gravity of the tray assembly 2 and the vehicle or container to successfully complete the lifting movement.

In an example, the output end of the driving device 6 needs to drive the second rotating shaft 3024 to move towards the first rotating shaft 3023 to complete the lifting movement. Therefore, the driving device 6 has a largest load when the handling robot performs the lifting movement. The elastic device 3026 may assist the driving device 6 in driving the second rotating shaft 3024 to move towards the first rotating shaft 3023, share the load of the driving device 6, and improve the efficiency of the handling robot in taking out the vehicle or container.

In an example of the present disclosure, the output end of the driving device 6 is a roller screw 61, and a screw nut 62 engaged with the roller screw 61 is disposed on the second rotating shaft 3024. When the driving device 6 drives the roller screw 61 to rotate, the screw nut 62 is threadedly fitted with the roller screw 61 to drive the second rotating shaft 3024 to move close to or away from the first rotating shaft 3023.

For example, the driving device 6 may be configured to drive the roller screw 61 to rotate in a direction, the screw nut 62 drives the second rotating shaft 3024 to move in a direction close to the first rotating shaft 3023, such that the tray assembly 2 moves upward.

In a case where the output end of the driving device 6 drives the roller screw 61 to rotate in another direction, the screw nut 62 drives the second rotating shaft 3024 to move away from the first rotating shaft 3023, such that the tray assembly 2 moves downward. That is, the driving device 6 may drive the roller screw 61 to rotate in two opposite directions, respectively. Accordingly, the screw nut 62 drives the second rotating shaft 3024 to move towards or away from the first rotating shaft 3023 due to the different rotating directions of the roller screw 61, thereby realizing the lifting movement of the tray assembly 2. The movement directions of the screw nut 62 in the case of different rotating directions of the roller screw 61 may be determined as required, which is not limited in the present disclosure.

In the present disclosure, a stopping part 63 is disposed at an end of the roller screw 61 passing through the screw nut 62, and the elastic device 3026 is disposed between the stopping part 63 and the screw nut 62. The stopping part 63 may be configured as a circular or square baffle with a diameter larger than that of the elastic device 3026, and the material of the baffle may be a hard material such as metal, thereby ensuring that the stopping part 63, together with the screw nut 62, may tightly press the elastic device 3026.

In a case where the tray assembly 2 of the handling robot moves downwards, the driving device 6 drives the screw nut 62 to move away from the first rotating shaft 3023 through the roller screw 61, and the second rotating shaft 3024 moves synchronously with the screw nut 62. After the screw nut 62 moves to contact with the elastic device 3026 and continues to move, the elastic device 3026 will be tightly pressed against the stopping part 63, and the elastic device 3026 obtains the elastic potential energy.

In a case where the tray assembly 2 of the handling robot moves upwards or needs to lift the vehicle or the container, the driving device 6 drives the screw nut 62 to move close to the first rotating shaft 3023 through the roller screw 61, and the second rotating shaft 3024 moves synchronously with the screw nut 62. Since the elastic device 3026 has the elastic potential energy at this time, the elastic potential energy of the elastic device 3026 will be converted into a pushing force to push the screw nut 62 towards the first rotating shaft 3023. That is, the elastic device 3026 will drive the screw nut 62 to move close to the first rotating shaft 3023 together with the roller screw 61 of the driving device 6, thereby reducing a torque output by the driving device 6 and reducing the load of the driving device 6.

In an example of the present disclosure, the elastic device 3026 is configured to be pre-pressed between the stopping part 63 and the screw nut 62 in a case where the stopping part 63 moves relative to the screw nut 62. That is, as long as the screw nut 62 moves away from the first rotating shaft 3023, the elastic potential energy of the elastic device 3026 will be increased, thereby ensuring that the elastic device 3026 may have the enough pushing force to assist the driving device 6 to work.

In an example of the present disclosure, the elastic device 3026 is configured to be pre-pressed between the stopping part 63 and the screw nut 62 after the stopping part 63 and the screw nut 62 move toward each other by a preset distance.

For example, in a case where the tray assembly 2 is located at a highest position in the height direction, the driving device 6 drives the screw nut 62 to move close to the stopping part 63 through the roller screw 61. After the screw nut 62 moves by the preset distance, the screw nut 62 is in contact with the elastic device 3026 and starts to press the elastic device 3026 in a direction towards the stopping part 63, such that the elastic potential energy of the elastic device 3026 gradually increases.

In an example, in a case where the tray assembly 2 is located at a lowest position in the height direction, after the driving device 6 drives the screw nut 62 to move away from the stopping part 63 by a preset distance through the roller screw 61, the elastic device 3026 is detached from the screw nut 62. That is, the elastic device 3026 has consumed all elastic potential energy.

The above two constructions both can achieve the state of natural elongation of the elastic device 3026, which ensures the expansion and contraction ability of the elastic device 3026 and prevents the elastic device 3026 from failing due to maintaining the deformation for a long time.

Referring to FIG. 1, in an example of the present disclosure, a supporting assembly 14 is disposed on the first chassis 11 and protruded from an end surface of the first chassis 11, and the tray assembly 2 is configured to be supported on the supporting assembly 14 in a case where the tray assembly is lowered to a preset height.

For example, referring to the view, the supporting assembly 14 may be configured as cuboid, thereby supporting the tray assembly 2 through the top surface. Two supporting assemblies 14 may be disposed at intervals and in parallel. By supporting the tray assembly 2 using two supporting assemblies 14, the tray assembly 2 may bear force evenly to ensure the stability of the tray assembly 2.

Since the height of the chassis assembly 1 is fixed, the height of the supporting assembly 14 is also fixed. In a case where the tray assembly 2 is lowered to the preset height, the top of the supporting assembly 14 contacts the bottom of the tray assembly 2 and supports the tray assembly 2, which may prevent the tray assembly 2 from being further lowered to crush other components on the chassis assembly 1.

Referring to FIG. 1, in an example of the present disclosure, driving wheels 15 are disposed at two opposite sides of the first chassis 11, and the supporting assembly 14 is configured to extend upward beyond the driving wheels 15.

For example, the driving wheel 15 has a certain diameter, and the supporting assembly 14 may be configured such that its height extending upward from the first chassis 1 is beyond the diameter of the driving wheel 15, such that the tray assembly 2 will be supported on the supporting assembly 14 in a case where the tray assembly 2 is lowered, thereby preventing the bottom of the tray assembly 2 from in contact with the driving wheel 15 to hinder the rotation of the driving wheel 15.

In an example of the present disclosure, the driving wheel 15 may be configured to be located at a middle position of the two opposite sides of the first chassis 11, and the supporting assembly 14 may be configured to extend upward beyond the driving wheels 15 from a direction close to the driving wheels 15, such that most of the pressure generated by the weight of the tray assembly 2 will be transferred to the driving wheel 15 through the supporting assembly 14 in a case where the supporting assembly 14 supports the tray assembly 2, which improves a load-bearing ratio of the driving wheel 15, such that the pressure of the driving wheel 15 on the working surface increases, the friction between the driving wheel 15 and the working surface is improved, and a ground grasping ability of the driving wheel 15 is improved, such that the driving wheel 15 may move more stably.

For example, referring to FIG. 1 and FIG. 2, the supporting assembly 14 may be disposed at a position on the first chassis 11 near the driving wheels 15. For example, the two driving wheels 15 may be coaxially and symmetrically disposed at two opposite sides of the first chassis 11, and the supporting assembly 14 may be perpendicular to a rotating axis of the driving wheel 15 and extend upward in the height direction beyond the top of the driving wheel 15. In a case where the tray assembly 2 is driven by the scissor lift assembly 3 to move such that the bottom of the tray assembly 2 is on the top of the supporting assembly 14, the supporting assembly 14 may share the entire gravity from the tray assembly 2 instead of the scissor lift assembly 3 and transfer the gravity to the two driving wheels 15. Compared with arranging the supporting assembly 14 at other positions, this position is more conducive to increasing the load-bearing ratio of the two driving wheels 15, which is beneficial to greatly improving the movement performance of the handling robot.

### Second Embodiment

The main differences of the second embodiment as compared with the first embodiment lie in the structure of the scissor lift assembly and a connection manner with the chassis assembly and the tray assembly. In order to keep the text concise, these differences are described in detail below with reference to FIG. 5 and FIG. 6, and the contents that are the same as the first embodiment will not be described in detail again.

Referring to FIG. 5 and FIG. 6, in an example, a scissor lift assembly 3 includes at least a third scissor arm 32 and a fourth scissor arm 31 hinged together, the third scissor arm 32 is hinged to a first scissor arm 34 through a fifth rotating shaft 3029, and the fourth scissor arm 31 is hinged to a second scissor arm 33 through a sixth rotating shaft 3030. A driving device 6 disposed between the fifth rotating shaft 3029 and the sixth rotating shaft 3030 is included, and the driving device 6 is configured to drive the fifth rotating shaft 3029 and the sixth rotating shaft 3030 to move away from or close to each other.

The connection relationship and movement relationship between the first scissor arm 34 and the second scissor arm 33 in this embodiment are the same as those described above, except that the bottom of the first scissor arm 34 is hinged to the top of the third scissor arm 32 through the fifth rotating shaft 3029, and the bottom of the second scissor arm 33 is hinged to the top of the fourth scissor arm 31.

The fitting relationship of the fifth rotating shaft 3029 and the sixth rotating shaft 3030 is the same as the fitting relationship of the first rotating shaft 3023 and the second rotating shaft 3024 as described above, and the driving device 6 is also the same as the driving device 6 described above.

In an example, the driving device 6 is configured to drive the sixth rotating shaft 3030 to move close to or away from the fifth rotating shaft 3029 through the output end.

For example, in a case where the driving device 6 drives the sixth rotating shaft 3030 to move away from the fifth rotating shaft 3029, the sixth rotating shaft 3030 drives the bottom of the second scissor arm 33 and the top of the third scissor arm 32 hinged therewith to move away from the fifth rotating shaft 3029, causing the first scissor arm 34, the second scissor arm 33, the third scissor arm 32 and the fourth scissor arm 31 to move close to each other in the height direction, thereby causing the scissor lift assembly 3 to drive the tray assembly 2 to lower.

In a case where the driving device 6 drives the sixth rotating shaft 3030 to move close to the fifth rotating shaft 3029, the sixth rotating shaft 3030 drives the bottom of the second scissor arm 33 and the top of the third scissor arm 32 hinged therewith to move close to the fifth rotating shaft 3029, causing the first scissor arm 34, the second scissor arm 33, the third scissor arm 32 and the fourth scissor arm 31 to move away from each other in the height direction, thereby causing the scissor lift assembly 3 to drive the tray assembly 2 to rise.

In addition, referring to FIG. 1 and FIG. 5, different from the above embodiment, two third scissor arms 32 are connected together at the bottom through the second rotating shaft 3024, rollers 25 are disposed at two ends of the second rotating shaft 3024, and the second chassis 12 is provided with a guiding groove 13 that is fitted with the roller 25. That is, in an example, the cooperation of the roller 25 with the guiding groove 13 is to guide the overall movement direction of the scissor lift assembly 3 by guiding the third scissor arm 32.

Furthermore, referring to FIG. 6, in an example, the driving device 6 is disposed between the first scissor arm 34 and the third scissor arm 32, that is, the driving device 6 works at a middle position of the scissor lift assembly 3, thereby making upper and lower parts of the driving device 6 bear force evenly, and improving the stability of the overall movement of the scissor lift assembly 3 driven by the driving device 6. On the basis of the scissor lift assembly including a first scissor arm, a second scissor arm, a third scissor arm and a fourth scissor arm provided in the present disclosure, those skilled in the art may obtain a combination of more scissor arms in the height direction according to the scissor lift assembly disclosed in the present disclosure to increase the lifting height of the scissor lift assembly, which will not be described one by one here.

### Third Embodiment

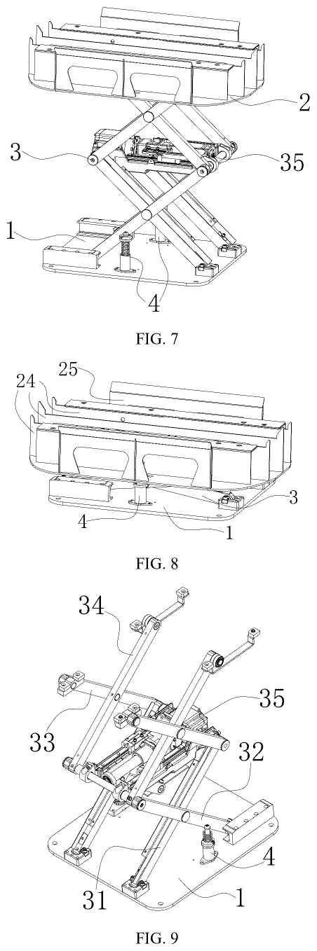

Referring to FIG. 7 and FIG. 8, the present disclosure provides a handling robot that may be configured to transfer a container stored in a storage area by lifting. The handling robot includes a chassis assembly 1, a tray assembly 2, a scissor lift assembly 3, and an assistive assembly 4, the chassis assembly 1 is configured to be supported on a working surface, and the tray assembly is configured to bear a container. The container may be a container used for loading goods and commodities in the field of logistics and warehousing, including but not limited to bins, cargo boxes, packing boxes, or the like, and the present disclosure does not limit the type and shape of the container.

The chassis assembly 1 is also able to drive the handling robot to travel on the working surface. The chassis assembly 1 may be provided with a driving wheel and/or an omnidirectional wheel cooperated with the driving wheel, and the driving wheel and the omnidirectional wheel are cooperated to together drive the handling robot to travel and turn on the working surface to facilitate the handling robot to transfer a container.

In an example of the present disclosure, as shown in FIG. 8, comb teeth 24 and baffles 25 are disposed on the tray assembly 2. The baffles 25 are disposed at two opposite sides of the tray assembly 2 and both have an inwardly inclined slope. The container may slide along the slope to a space between the two baffles 25, thereby being stably supported on the tray assembly 2. There may be a plurality of comb teeth 24, and there is a gap between any two adjacent comb teeth 24, such that the comb teeth 24 may insert into the gap of a bearing part of a shelf. The container may be directly supported on the comb teeth 24, and the gap between any two adjacent comb teeth 24 should be less than an outer diameter of a smallest container, thereby ensuring that the container may be stably supported on the comb teeth 24.

The scissor lift assembly 3 is disposed between the chassis assembly 1 and the tray assembly 2, and is configured to be controlled by a driving mechanism 35 to drive the tray assembly to move between an initial position and a lifting position in a height direction. FIG. 7 shows the handling robot in the lifting position, and FIG. 8 shows the handling robot in the initial position. The scissor lift assembly 3 has a multi-level scissor arm structure. In a case where the scissor lift assembly 3 is in the initial position, an included angle between the scissor arms is small, and a large lifting driving force is needed to drive the scissor lift assembly to start moving to the lifting position. However, after breaking through a certain lifting threshold, a driving force required by the scissor lift assembly 3 is greatly reduced.

Referring to FIG. 9, in an example of the present disclosure, the scissor lift assembly 3 includes a primary scissor and a secondary scissor from bottom to top, the primary scissor includes a fourth scissor arm 31 and a third scissor arm 32, and the secondary scissor includes a second scissor arm 33 and a first scissor arm 34. It may be understood that two primary scissors are provided, and are supported at two sides of the tray assembly 2, respectively; and two secondary scissors are provided, and are supported at two sides of the tray assembly 2, respectively. A first end of the fourth scissor arm 31 is hinged to the chassis assembly 1, a second end of the fourth scissor arm 31 is hinged to a first end of the second scissor arm 33, and a second end of the second scissor arm 33 is hinged to the tray assembly 2. A first end of the third scissor arm 32 is slidably connected to the chassis assembly 1, and a second end of the third scissor arm 32 is hinged to a first end of the first scissor arm 34, and a second end of the first scissor arm 34 is slidably connected to the tray assembly 2.

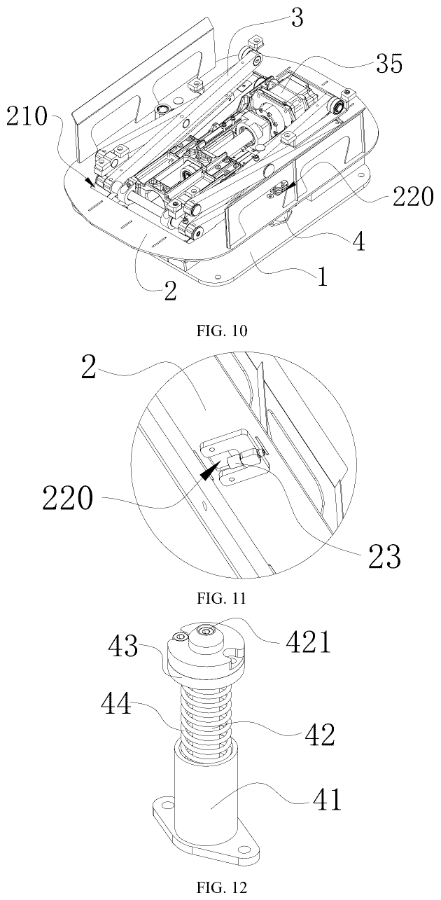

The driving mechanism 35 may be installed at a middle position of the scissor lift assembly 3. Referring to FIG. 10, the tray assembly 2 is provided with a through opening 210. In a case where the handling robot is in the initial position, the driving mechanism 35 and a part of the scissor lift assembly 3 may pass through the through opening 210, thereby ensuring that the tray assembly 2 may be lowered to a low position as much as possible. In a case where the driving mechanism 35 is started, the scissor lift assembly 3 may be expanded outward or moved inward, driving the first end of the third scissor arm 32 to slide relative to the chassis assembly 1, and the second end of the first scissor arm 34 to slide relative to the tray assembly 2, thereby driving the fourth scissor arm 31 and the second scissor arm 33 to rotate, and causing the tray assembly 2 to move up and down.

It may be seen that the driving mechanism 35 needs to provide the driving force for rotation of the fourth scissor arm 31 and the second scissor arm 33. In a case where the tray assembly 2 is in the initial position, the included angle between the scissor arms is very small, and a larger driving force is needed to make the fourth scissor arm 31 and the second scissor arm 33 rotate. When selecting the driving mechanism, a maximum driving force required by the scissor lift assembly 3 in the whole movement needs to be considered. If it is possible to reduce a peak driving force, a driving mechanism with a lower power may be selected, thereby reducing the cost. For this, the handling robot according to the present disclosure is provided with an assistive assembly.

As shown in FIG. 7, the assistive assembly 4 is disposed between the chassis assembly 1 and the tray assembly 2, and the tray assembly 2 is configured to move to the initial position under control of the driving mechanism 35 and by resisting against an elastic force of the assistive assembly 4, and/or is configured to move to a lifting position under control of the driving mechanism 35 and under the elastic force of the assistive assembly 4. The assistive assembly 4 has an elastic device capable of storing energy, and in a case where the tray assembly 2 moves towards the initial position, the elastic device is compressed to store energy. The stored energy may be released during a next upward movement of the tray assembly 2 from the initial position, and the assistive assembly 4 provides a vertical upward elastic force for the tray assembly 2, thereby reducing the lifting force required to be provided by the driving mechanism 35.

According to the present disclosure, the assistive assembly 4 is disposed between the chassis assembly 1 and the tray assembly 2, such that the tray assembly 2 may obtain a vertical upward elastic assisting force from the assistive assembly 4 during lifting, thereby reducing the requirement for the power of the driving mechanism 35. The assistive assembly 4 may provide the vertical upward elastic assisting force at least in the initial stage when the scissor lift assembly 3 moves from the initial position towards the lifting position. Compared with a horizontal assistive device, the assistive assembly 4 according to the present disclosure directly provides the vertical assisting force to ensure that the assisting force is used for lifting to a greatest extent, thereby effectively reducing the loss of the assisting force.

In an example of the present disclosure, the assistive assembly 4 is configured to be pre-pressed between the tray assembly 2 and the chassis assembly 1 during the movement of the tray assembly 2 relative to the chassis assembly 1. In an example, in a case where the scissor lift assembly 3 moves to a highest lifting position, the assistive assembly 4 may still provide the vertical upward elastic assisting force for the tray assembly 2. In the whole process where the tray assembly 2 moves towards the initial position, it needs to overcome the elastic force of the assistive assembly 4. In a case where the elastic force to be overcome by the tray assembly 2 is greater than the sum of its own gravity and the gravity of the container, the driving mechanism 35 is required to provide a part of the driving force during the descending process. In this way, the assistive assembly 4 may provide the upward assisting force for the tray assembly 2 in the whole lifting process, thereby reducing the driving force demand in the whole lifting process and reducing the driving cost.

In an example of the present disclosure, the assistive assembly 4 is configured to be pre-pressed between the tray assembly 2 and the chassis assembly 1 after the tray assembly 2 moves a preset distance from the lifting position to the initial position, and is configured to detach from the chassis assembly 1 or the tray assembly 2 after the tray assembly 2 moves a preset distance from the initial position to the lifting position. In this way, the assistive assembly 4 may provide the assisting force at an initial lifting stage, and the assistive assembly 4 may be detached from the chassis assembly 1 or the tray assembly 2 and do not provide the assisting force for the tray assembly 2 anymore, after the tray assembly 2 moves upward to a certain height. The force that needs to be provided by the driving mechanism 35 at the initial lifting stage is much greater than the driving force provided later, so provision of the assisting force at the initial lifting stage may effectively reduce the peak output force of the driving mechanism 35, such that the driving mechanism 35 with a lower power may be selected to save the driving cost.

The above examples all can achieve the assisting effect and save the driving cost. In an example, as shown in FIG. 7, the latter example is selected, that is, the assistive assembly 4 is set, which only provides the assisting force at the initial stage.

In an example of the present disclosure, the assistive assembly 4 is configured to extend in a vertical direction and includes a connecting part and a movable part 43 pre-pressed on the connecting part, the connecting part is secured to the chassis assembly, and the movable part 43 is configured for fitting with the tray assembly 2; or the connecting part is secured to the tray assembly 2, and the movable part 43 is configured for fitting with the chassis assembly 1. The connecting part is a part of the assistive assembly 4 that is fixedly connected to the tray assembly 2 or the chassis assembly 1, and the movable part 43 is able to move relative to the fixed part, thereby realizing the power storage and assisting functions.

The assistive assembly 4 may be installed on an upper side of the chassis assembly 1 or a lower side of the tray assembly 2. In an example, as shown in FIG. 7, the assistive assembly 4 is installed on the chassis. In a case where the assistive assembly 4 is installed on the chassis assembly 1, after the tray assembly 2 is lowered to a position where it is in contact and fitted with the assistive assembly 4, the tray assembly 2 is fitted with an upper end surface of the movable part 43, and presses the movable part 43 downward to store the elastic force. At the initial lifting stage of the tray assembly 2, the upper end surface of the movable part 43 lifts the tray assembly 2 upward, thereby providing the assisting force to the tray assembly 2. In a case where the assistive assembly 4 is installed on the lower surface of the tray assembly 2, after the tray assembly 2 is lowered by a certain distance, the lower end surface of the movable part 43 is able to fit with the chassis assembly 1 and accumulate elastic force during the descending process. At the initial lifting stage of the tray assembly 2, the lower end surface of the movable part 43 abuts against the chassis assembly 1 under the elastic force, thereby providing the assisting force to the tray assembly 2.

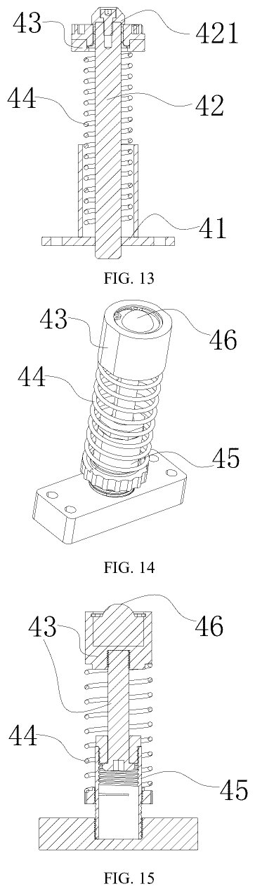

In an example of the present disclosure, referring to FIG. 12 and FIG. 13, the connecting part includes a fixing base 41 and a guiding rod 42 extending from the fixing base 41 in a vertical direction; the movable part 43 is sleeved on the guiding rod 42; an energy storage member 44 is disposed between the fixing base 41 and the movable part 43, and the energy storage member 44 is configured to make the movable part 43 have a tendency to move away from the fixing base 41 to provide a vertically upward elastic force to the tray assembly 2. The guiding rod 42 may be integrally formed with the fixing base 41, or may be fixedly connected in the fixing base 41. The movable part 43 may have a structure of sliding sleeve, and the sliding sleeve may be slidably sleeved on the guiding rod 42 and may slide up and down along the guiding rod 42. A limiting member 421 is provided at an upper end part of the guiding rod 42, and the limiting member 421 is configured to have an outer diameter greater than an inner diameter of the movable part 43, thereby preventing the movable part 43 from escaping from the guiding rod 42 during the movement.

The energy storage member 44 may be a spring-type, gas-type, or hydraulic type energy storage member 44. In an example, the spring-type energy storage member 44 is used. The energy storage member 44 is sleeved on the guiding rod 42 and is pre-pressed between the fixing base 41 and the movable part 43. When the movable part 43 is pressed downward by the tray assembly 2, the energy storage member 44 is pressed synchronously to store the elastic force, and at the initial stage of upward movement of the tray assembly 2, the energy storage member 44 provides the elastic assisting force.

In an example of the present disclosure, referring to FIG. 10 and FIG. 11, a through hole 220 is defined at an abutment position of the tray assembly 2 or the chassis assembly 1, and the through hole 220 is configured to have a diameter that is greater than a diameter of the guiding rod 42 and less than a diameter of the movable part 43. FIG. 11 is a schematic diagram illustrating a bottom structure of the tray assembly 2 at the position of the through hole 220. The through hole 220 is configured to enable the guiding rod 42 to pass therethrough to above the tray assembly 2, such that the upper end surface of the movable part 43 is kept in contact with the bottom surface of the tray assembly 2. The diameter of the through hole 220 is greater than that of the guiding rod 42. Since the top end of the guiding rod 42 is provided with the limiting member 421, the diameter of the through hole 220 needs to be greater than that of the limiting member 421. The diameter of the through hole 220 is less than the outer diameter of the movable part 43, to prevent the movable part 43 from passing through the through hole 220.

In an example of the present disclosure, the assistive assembly 4 may have other types of structural features. Referring to FIG. 14 and FIG. 15, the connecting part includes a fixing sleeve 45, and the movable part 43 is configured to be movably connected within the fixing sleeve 45; and an energy storage member 44 is disposed between the fixing sleeve 45 and the movable part 43, and is configured to make the movable part 43 have a tendency to move outward to provide a vertically upward elastic force to the tray assembly 2. In an example, the movable part 43 is a cylindrical structure slidably connected in the fixing sleeve 45, the upper end of the movable part 43 is constructed as an abutment structure with a greater diameter, and the lower end of the movable part 43 is constructed as a sliding rod structure with a smaller diameter. The abutment structure at the upper end of the movable part 43 is able to fit with and abut against the lower surface of the tray assembly 2, and the sliding rod at the lower end of the movable part 43 is able to extend into the fixing sleeve 45 for movement. The bottom end of the sliding rod may be provided with a protruding structure, to prevent the whole movable part 43 from escaping from the top of the fixing sleeve 45. The energy storage member 44 is sleeved on the sliding rod of the movable part 43, and is pre-pressed between the abutment structure and the fixing sleeve 45. When the movable part 43 is pressed downward by the tray assembly 2, the energy storage member 44 is pressed synchronously to store the elastic force; and at the initial stage of the upward movement of the tray assembly 2, the energy storage member 44 provides the elastic assisting force.

In an example of the present disclosure, the assistive assembly 4 may have another structural feature. Referring to FIG. 17, the movable part 43 includes a sliding rod 47 and a bullseye bearing 46, the sliding rod 47 is configured to be slidably connected within the fixing sleeve 45 and is configured to have a tendency to move outward under an action of the energy storage member 44; and the bullseye bearing 46 is configured to be detachably connected to a top end of the sliding rod 47 and is configured to abut against the chassis assembly 1 or the tray assembly 2. The handling robot may shake during the movement, resulting in the abrasion of the contact surface. For this, in an example, the bullseye bearing 46 is used to abut against the chassis assembly 1 or the tray assembly 2, to reduce the friction force at an abutment position. In an example, the bullseye bearing 46 is detachably connected to the top end of the sliding rod 47. The user may fix the bullseye bearing 46 to the top end of the sliding rod 47 by a screw, and replace the bullseye bearing conveniently and quickly when it is worn.

The bottom end of the sliding rod 47 is constructed as a protrusion, and a sealing member 451 is disposed at an upper opening of the fixing sleeve 45. The sealing member 451 may play a limiting role. The sealing member 451 is configured to abut against the protrusion 471 when the sliding rod 47 moves to a highest position, to prevent the sliding rod 47 from escaping from the fixing sleeve 45 under the action of the energy storage member 44. The bullseye bearing 46 includes a bearing body 461 and an abutment member 462, the bearing body 461 may be detachably connected to the top end of the sliding rod 47 through threads, and the abutment member 462 is configured to be squeezed between the bearing body 461 and the sliding rod 47 in a case where the bearing body 461 is mounted on the top end of the sliding rod 47. In this way, the bearing body 461, the abutment member 462 and the sliding rod 47 together form the movable part 43 which may move integrally. A lower end surface of the abutment member 462 is configured for abutting against the energy storage member 44, such that the movable part 43 is pre-pressed on the connecting part as a whole.

The above describes some examples of the assistive assembly 4, the assistive assembly 4 may have other types of structures, and the present disclosure does not limit the structural features of the assistive assembly 4.

In an example of the present disclosure, referring to FIG. 7, at least two assistive assemblies are provided, and the at least two assistive assemblies 4 are disposed at two opposite sides of the chassis assembly 1 and configured to fit with two corresponding sides of the tray assembly 2; or the at least two assistive assemblies 4 are disposed at two opposite sides of the tray assembly 2 and configured to fit with two corresponding sides of the chassis assembly 1. The symmetrical arrangement of two assistive assemblies 4 at two sides of the tray assembly 2 or the chassis assembly 1 is able to make the assisting force more uniform, and may prevent the scissor lift assembly 3 from tilting or mechanically jamming in the lifting process due to unbalanced force at the two sides on the one hand, and may provide double assisting forces to further reduce the peak output force of the driving mechanism 35 on the other hand.

In an example of the present disclosure, referring to FIG. 11, a rolling part 23 is disposed between the chassis assembly 1 and the movable part 43, the chassis assembly 1 is configured to rollably fit with the movable part 43 through the rolling part 23, and the rolling part 23 is configured to roll between the chassis assembly 1 and the movable part 43 in a case where the tray assembly 2 rocks relative to the chassis assembly 1; or a rolling part 23 is disposed between the tray assembly 2 and the movable part 43, the tray assembly 2 is configured to rollably fit with the movable part 43 through the rolling part 23, and the rolling part 23 is configured to roll between the tray assembly 2 and the movable part 43 in a case where the tray assembly 2 rocks relative to the chassis assembly 1. In a case where the assistive assembly 4 is fixed on the tray assembly 2, the rolling part 23 may be disposed on the chassis assembly 1. In a case where the assistive assembly 4 is fixed on the chassis assembly 1, the rolling part 23 may be disposed on the tray assembly 2. In addition, the rolling part 23 may be directly disposed on the movable part 43. The rolling part 23 should be disposed at the position where the movable part 43 abuts against the chassis assembly 1 or the tray assembly 2, such that rolling occurs between the movable part 43 and the chassis assembly 1 or the tray assembly 2.

In an example of the present disclosure, the rolling part 23 is a rolling shaft, and a rotation axis of the rolling shaft is perpendicular or parallel to a traveling direction of the handling robot. During the traveling process of the handling robot, the tray assembly 2 is prone to slightly shake relative to the chassis assembly 1, and at this time, if the movable part 43 of the assistive assembly 4 is in the abutment position, the top end will be rubbed, and the abutment surface will be worn. In order to reduce the friction at the abutment position, the present disclosure provides a rolling part 23, which may be a ball transfer unit or a rolling shaft. Since a rotation direction of the rolling shaft is fixed, its rotation axis needs to be perpendicular or parallel to the traveling direction of the handling robot, thereby reducing the friction at the abutment position when the tray assembly 2 rocks.

In an example of the present disclosure, referring to FIG. 14, the rolling part 23 is a bullseye bearing 46, and the bullseye bearing 46 is installed at the position where the movable part 43 abuts against the tray assembly 2. In an example, the bullseye bearing 46 may be installed at the top of the movable part 43, when the tray assembly 2 rocks relative to the chassis assembly 1, the bottom surface of the tray assembly 2 directly abuts against the bullseye bearing 46, thereby reducing the friction at the abutment position and reducing the abrasion of the abutment surface.

The present disclosure also provides another method to reduce friction. In an example of the present disclosure, the movable part 43 of the assistive assembly 4 has a curved surface, and the curved surface of the movable part 43 is configured to abut against the chassis assembly 1 or the tray assembly 2. The top of the movable part 43 is constructed as the curved surface, which may effectively reduce the friction force at the abutment position. When the tray assembly 2 rocks relative to the chassis assembly 1, the curved surface may ensure the point contact at the abutment position, without causing excessive friction.

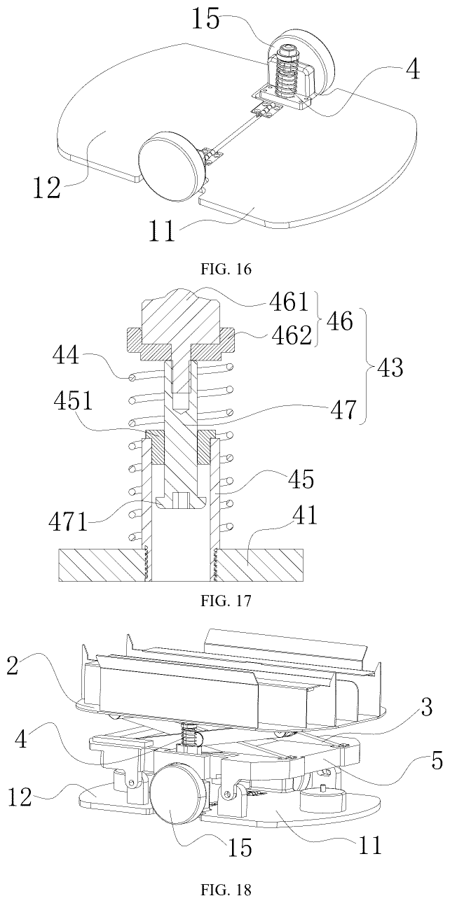

In an example of the present disclosure, referring to FIG. 16, the chassis assembly 1 includes a driving wheel 15, and the driving wheel 15 may be disposed at each of the two sides of the chassis assembly 1, thereby driving the handling robot to travel and turn on the working surface. The assistive assembly 4 is disposed at a position corresponding to the driving wheel 15, and the tray assembly 2 is configured to apply a positive pressure to such a position of the chassis assembly 1 that corresponds to the driving wheel 15 through the assistive assembly 4. The tray assembly 2 will apply a downward pressure to the assistive assembly 4, and the assistive assembly 4 fixed at such a position of the chassis assembly 1 that corresponds to the driving wheel 15 will transfer the pressure downward, thereby applying a downward positive pressure to the position of the driving wheel 15 on the chassis assembly 1. Applying the positive pressure to the position of the driving wheel 15 will make the driving wheel 15 adhere to the working surface more tightly, thereby making the handling robot travel more smoothly.

In an example of the present disclosure, referring to FIG. 16, the chassis assembly 1 includes a first chassis 11 and a second chassis 12 hinged to the first chassis 11. The first chassis 11 and the second chassis 12 are configured to be co-supported on the working surface. The second chassis 12 may be connected to the first chassis via a hinge, and the second chassis 12 is able to rotate relative to the first chassis 11 around the hinge. Two hinges may be arranged at intervals and in parallel to ensure the stability of relative rotation between the second chassis 12 and the first chassis 11.

In a case where the handling robot works, the handling robot moves according to a preset path or a traveling direction. When the handling robot enters a working surface with a slope or crosses an obstacle, the second chassis 12 of the chassis assembly 1 will adaptively deflect relative to the first chassis 11 due to the change of the slope of the working surface. For example, in a case where the second chassis 12 travels to a working surface with an ascending slope, the second chassis 12 is deflected clockwise around a rotation axis relative to the first chassis 11 to adapt to the ascending slope, with a hinged position of the first chassis 11 and the second chassis 12 as the rotation axis. Similarly, in a case where the second chassis 12 travels to a working surface with a descending slope, the second chassis 12 is deflected counterclockwise around the rotation axis relative to the first chassis 11 to adapt to the descending slope. In the above cases, the second chassis 12 is adaptively deflected according to the slope of the working surface, to prevent severe jolts that would otherwise occur when directly entering a sloped working surfaces, and thus prevent the container carried by the handling robot from falling, and improve the stability of the handling robot in transferring goods.

The scissor lift assembly 3 is disposed on the chassis assembly 1 and is configured to move along an extending direction of the first chassis 11 and the second chassis 12 of the chassis assembly 1 to increase or decrease a size of the scissor lift assembly 3 in a height direction. The scissor lift assembly 3 includes at least a fourth scissor arm 31 and a third scissor arm 32 hinged together. The fourth scissor arm 31 and the third scissor arm 32 are close to or far away from each other at the top and bottom to increase or decrease the size of the scissor lift assembly 3 in the height direction, thereby driving the tray assembly 2 to move up or down. The bottom of one of the fourth scissor arm 31 and the third scissor arm 32 is connected to a position of the first chassis 11 away from the second chassis 12. The bottom of the other one of the fourth scissor arm 31 and the third scissor arm 32 is connected to a position of the second chassis 12 away from the first chassis 11. For example, the bottom of the fourth scissor arm 31 is connected to a position of the first chassis 11 away from the second chassis 12, the bottom of the third scissor arm 32 is connected to a position of the second chassis 12 away from the first chassis 11, and the bottom of the fourth scissor arm 31 and the bottom of the third scissor arm 32 are close to or away from each other along the extension direction of the first chassis 11 and the second chassis 12.

Due to the arrangement of the second chassis 12 with a movable space, the overall support of the chassis assembly 1 may not be stable enough. Both ends of the chassis assembly 1 will be subjected to the pressure of the scissor lift assembly 3, which will cause the connection position between the first chassis 11 and the second chassis 12 to arch upward. As shown in FIG. 16, the driving wheel 15 installed at the middle position of the chassis assembly 1 will be subjected to an upward force, and has a tendency to float upward, thereby affecting the stability of transporting goods. In view of this, in an example, the assistive assembly 4 is disposed near the driving wheel 15 to provide a downward positive pressure for the driving wheel 15, thereby ensuring that the driving wheel 15 may cling to the ground and provide stable support.

The driving wheel 15 is disposed on the first chassis 11, and the assistive assembly 4 is disposed at such a position of the first chassis 11, the second chassis 12 or the tray assembly 2 that is near the driving wheel 15. As shown in FIG. 16, the assistive assembly 4 may be disposed at such a position on the first chassis 11 that is near the driving wheel 15. The assistive assembly 4 may also be disposed at other positions near the driving wheel 15. For example, the assistive assembly 4 may be disposed at such a position on the second chassis 12 that is near the driving wheel, or the assistive assembly 4 may be disposed on the tray assembly 2, and the position where the assistive assembly 4 abuts against the chassis assembly 1 is near the driving wheel 15. In this way, the downward positive pressure is provided for the driving wheel 15, thereby overcoming the problems caused by the arrangement of the second chassis 12, and improving the support stability of the chassis assembly 1.

In an example of the present disclosure, in order to further improve the stability of the handling robot, referring to FIG. 18, a movable platform 5 is further disposed between the chassis assembly 1 and the tray assembly 2. In an example, as shown in FIG. 18, the chassis assembly 1 also includes a first chassis 11 and a second chassis 12 hinged to the first chassis 11, and the first chassis 11 and the second chassis 12 are configured to be co-supported on the working surface. The handling robot further includes the movable platform 5, a first side of the movable platform 5 is hinged to the second chassis 12, and a second side of the movable platform 5 is movably connected to the first chassis 11. It should be noted that the structure of the first chassis 11 may be the same as that of the second chassis 12, with the different names for convenience of description. That is, the first side of the movable platform 5 may be hinged to the first chassis 11, and the second side of the movable platform 5 may be movably connected to the second chassis 12. The scissor lift assembly 3 is disposed between the movable platform 5 and the tray assembly 2, and is configured to drive the tray assembly 2 to move between the initial position and the lifting position in the height direction under the control of the driving mechanism 35.

In the solution where the second chassis 12 is provided, but without the movable platform 5, the bottom of the scissor lift assembly 3 is directly connected to the two chassis, which will result in the main pressure on the chassis assembly 1 being applied to the second chassis 12 and the first chassis 11, respectively. The force on both sides may cause the chassis assembly 1 to be subjected to less force at the middle hinged position. Even if the assistive assembly 4 is disposed at the position of the driving wheel 15, the chassis assembly 1 may still be unstable in support. In view of this, in an example, the movable platform 5 is disposed between the chassis assembly 1 and the tray assembly 2, and the scissor lift assembly 3 is disposed between the movable platform 5 and the tray assembly 2, such that the scissor lift assembly 3 may directly apply the pressure on the movable platform 5, and the pressure subjected by the chassis assembly 1 directly comes from the movable platform 5.

As shown in FIG. 18, a position where the movable platform 5 is connected to the chassis assembly 1 is near the driving wheel 15. Compared with the solution of directly installing the scissor lift assembly 3 on the chassis assembly, the movable platform 5 may effectively concentrate the positive pressure, such that all the forces from the scissor lift assembly 3, the tray assembly 2 and the handled container may be concentrated to the movable platform 5. No matter how the scissor lift assembly 3 moves or where the handled container is placed on the tray assembly 2, the movable platform 5 is able to transfer the pressure from the above to the position near the driving wheel 15, thereby increasing the positive pressure at the position of the driving wheel 15 and improving the traveling stability of the handling robot.

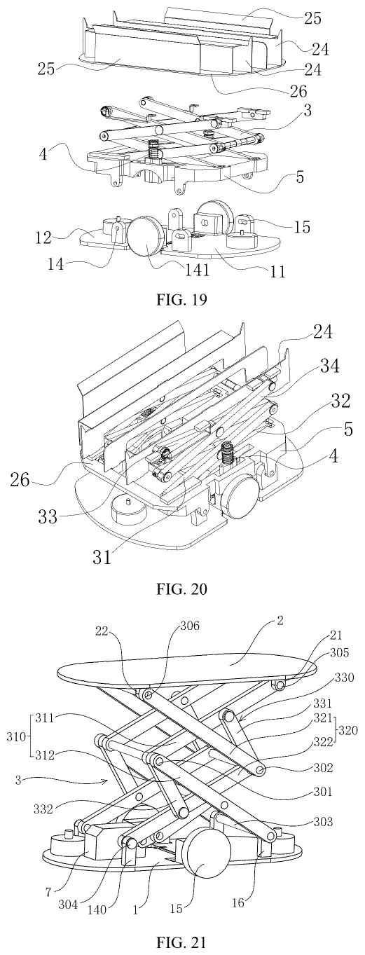

As shown in FIG. 19, four groups of protruding connectors may be disposed on the chassis assembly 1, and the movable platform 5 is connected to the chassis assembly 1 through the connectors. In an example, two connectors located at a side of the second chassis 12 are respectively provided with hinge holes 14, and a side of the movable platform 5 is hinged to the second chassis 12 through the two hinge holes 14. Two connectors located at a side of the first chassis 11 are respectively provided with waist holes 141, and the other side of the movable platform 5 is slidably connected to the first chassis 11 through the two waist holes 141. In a case where the handing robot travels on an uneven working surface, the second chassis 12 may float relative to the first chassis 11. At this time, the movable platform 5 may also float relative to the chassis assembly 1, thereby ensuring that the handling robot may travel smoothly. In addition to the above slot connection manner, the movable platform 5 may also be movably connected to the chassis assembly 1 in other ways, for example, a form of four-bar linkage may be adopted, which is not limited by the present disclosure.

In an example of the present disclosure, the assistive assembly 4 is disposed on the movable platform 5, or the assistive assembly 4 is disposed at a position of the tray assembly 2 that is near the driving wheel 15, and the tray assembly 2 is configured to apply the positive pressure to such a position of the chassis assembly 1 that corresponds to the driving wheel 15 through the assistive assembly 4 and the movable platform 5. In an example, the assistive assembly 4 may be directly mounted on the movable platform 5, or the assistive assembly 4 may also be mounted on the tray assembly 2 at a position near the driving wheel 15 and directly abutted against the movable platform 5. The pressure from the tray assembly 2 may fall on the assistive assembly 4, and the assistive assembly 4 may transmit the pressure downward to the movable platform 5. Since the movable platform 5 is installed on the chassis assembly 1 at the position near the driving wheel 15, the positive pressure at the position of the driving wheel 15 is increased, and the stability of the handling robot is enhanced.

In an example of the present disclosure, referring to FIG. 20, the assistive assembly 4 is disposed at such a position of the first chassis 11, the second chassis 12 or the tray assembly 2 that is near the driving wheel 15, and is configured to penetrate the movable platform 5. In an example, the assistive assembly 4 is disposed at the position of the chassis assembly 1 or the tray assembly 2 that is near the driving wheel 15. For example, an installation area may be provided at an inner position of the driving wheel 15 on the first chassis 11, and the assistive assembly 4 may be installed here, thereby providing assisting force for the tray assembly 2. The assistive assembly 4 needs to penetrate the movable platform 5 to be supported on the tray assembly 2, so a notch needs to be provided at such a position of the movable platform 5 that corresponds to the assistive assembly 4 for the assistive assembly 4 to penetrate. In this way, the pressure subjected by the assistive assembly 4 may also be transmitted to the position near the driving wheel 15, thereby increasing the positive pressure at the position of the driving wheel 15 and enhancing the stability of the handling robot.

In an example of the present disclosure, referring to FIG. 19 and FIG. 20, the tray assembly 2 includes a tray body 26 and at least two comb teeth 24 disposed on the tray body 26 at intervals. The assistive assembly 4 directly abuts against or is directly installed on a bottom surface of the tray body 26, and the comb teeth 24 are plate-shaped structures that are vertically supported upward from the tray body 26. The tray body 26 and the bottom of the comb teeth 24 provide a space for accommodating the scissor lift assembly 3. The tray body 26 is provided with a through opening 210 that is wide enough for the widest position of the scissor lift assembly 3 to pass through, and the bottom of the comb teeth 24 is provided with a corresponding notch. As shown in FIG. 20, the top of the scissor lift assembly 3 is configured to penetrate the tray body 26 and is configured to be connected to the side wall of the comb teeth 24. In this way, the height of the handling robot may be reduced and the space occupied by the handling robot may be reduced. In a case where the scissor lift assembly 3 is at the initial position, the scissor lift assembly 3 may be accommodated in the tray assembly 2, such that the height of the tray assembly 2 at the initial position decreases, which is convenient for the user to access the container, and at the same time, the center of gravity of the handling robot is lowered, thereby further enhancing the stability of the handling robot.

In an example of the present disclosure, the scissor lift assembly 3 at least includes a fourth scissor arm 31 and a third scissor arm 32 hinged together. The bottom of one of the fourth scissor arm 31 and the third scissor arm 32 is hinged to a side of the movable platform 5, and the bottom of the other one of the fourth scissor arm 31 and the third scissor arm 32 is slidably connected to the other side of the movable platform 5. For example, the bottom of the fourth scissor arm 31 may be hinged to a position at a side of the movable platform 5 corresponding to the second chassis 12, and the bottom of the third scissor arm 32 may be slidably connected to a position at a side of the movable platform 5 corresponding to the first chassis 11. The bottom of the fourth scissor arm 31 and the bottom of the third scissor arm 32 are close to or away from each other along the extension direction of the movable platform 5.

In an example, the scissor lift assembly 3 may also include a second scissor arm 33 and a first scissor arm 34 hinged together, the bottom of the second scissor arm 33 is hinged to the top of the fourth scissor arm 31, and the bottom of the first scissor arm 34 is hinged to the top of the third scissor arm 32. As shown in FIG. 20, the top of the second scissor arm 33 is hinged to a sidewall of the comb teeth 24, the top of the first scissor arm 34 is slidably connected to the sidewall of the comb teeth 24, and the top of the second scissor arm 33 and the top of the first scissor arm 34 are close to or away from each other along the extension direction of the movable platform 5.

In an example of the present disclosure, GI represents a force downward caused by the gravity of the tray assembly in an unloaded state, G2 represents a maximum container weight bearable by the tray assembly; F represents a maximum elastic force of the assistive assembly in a case where the tray assembly is at the initial position, and Fp represents a peak driving force provided by the driving mechanism. The energy storage member 44 of the assistive assembly 4 may have different elastic coefficients, thereby providing different elastic forces. With different maximum elastic force F, the peak driving force Fp provided by the driving mechanism 35 will also change, which will lead to a change in the selection of the driving mechanism 35. When selecting the driving mechanism 35, it needs to select such a driving mechanism 35 that has a peak driving force Fp greater than or equal to a required peak output force, thereby ensuring the normal operation of the handling robot. The value of F needs to be classified and discussed below, thereby obtaining the corresponding standard for the selection of the driving mechanism 35.

When FSG1, regardless of unloaded or full load, the driving mechanism 35 may be directly disconnected in a case where the tray assembly 2 moves towards the initial position. Under the action of gravity, the tray assembly 2 is able to move to the initial position and press the movable part 43 to the lowest position. At this time, the driving force required to be provided by the driving mechanism 35 is G1+G2−F, and selection of a driving mechanism 35 that has a peak driving force Fp≥G1+G2−F may satisfy the operation requirement of the handling robot.

When F>G1, the driving mechanism 35 may need to provide a force during the descending process of the tray assembly 2. In the unloaded state and at a lowest position, the driving mechanism 35 needs to overcome the elastic force of the assistive assembly 4, and the output force in this case is F−G1. In a fully load state, the output lifting force of the driving mechanism 35 is G1+G2−F. When selecting the driving mechanism 35, it needs to comprehensively consider the above two limit cases and make Fp not less than the larger one of the above output forces.

A special case is that the driving mechanism 35 outputs the equal force in the above two scenarios, in this case, F−G1=G1+G2−F, so F=G1+G2/2. By substituting F into the above equation, it may be found that the driving force required to be provided by the driving mechanism 35 is G2/2, so selection of a driving mechanism 35 having a peak driving force Fp≥G2/2 may satisfy the operation requirement of the handling robot.

When G1<F<G1+G2/2, G1+G2−F>F−G1. That is, the maximum driving force required to be provided by the driving mechanism 35 is G1+G2−F, so selection of a driving mechanism 35 having a peak driving force Fp≥G1+G2−F may satisfy the operation requirement of the handling robot.

When F>G1+G2/2, F−G1>G1+G2−F. That is, the maximum driving force required to be provided by the driving mechanism 35 is F−G1, so selection of a driving mechanism 35 having a peak driving force Fp≥F−G1 may satisfy the operation requirements of the handling robot.

The present disclosure further provides an assistive device, which includes a connecting part and a movable part 43. The movable part 43 is configured to be pre-pressed on the connecting part through an energy storage member 44. The energy storage member 44 may be a spring-type, gas-type, or hydraulic type energy storage member 44. In an example, a spring-type energy storage member 44 is used. Referring to FIG. 17, the movable part 43 includes a sliding rod 47 and a bullseye bearing 46, the sliding rod 47 is slidably connected to the connecting part, and the bullseye bearing 46 is detachably connected to a free end of the sliding rod 47. The bullseye bearing 46 is detachably connected to the top end of the sliding rod 47, such that the user may replace it conveniently and quickly. The assistive device may provide assisting force for various kinds of lifting mechanisms, thereby reducing the lifting force required to be provided by the divice and reducing the peak lifting force.

In an example of the present disclosure, as shown in FIG. 17, the connecting part includes a fixing base 41 and a fixing sleeve 45, the fixing sleeve 45 is screwed to the fixing base 41. A bottom end surface of the fixing base 41 is constructed as a plane, such that it is convenient for the user to install the fixing base 41 to a certain plane of other equipment to provide lifting assistive force for that equipment, for example, the fixing base 41 may be fixed on the chassis assembly 1 of the above handling robot. The sliding rod 47 is slidably connected within the fixing sleeve 45 and is configured to have a tendency to move outward under an action of the energy storage member 44. In an example, a bottom end of the sliding rod 47 is constructed as a protrusion 471, and a sealing member 451 is disposed at a position of an upper opening of the fixing sleeve 45 and configured to abut against and fit with the protrusion 471 in a case where the sliding rod 47 moves to a highest position. The sealing member 451 may play a limiting role, preventing the sliding rod 47 from escaping from the fixing sleeve 45 under the action of the energy storage member 44.

The bullseye bearing 46 includes a bearing body 461 and an abutment member 462, and the bearing body 461 is detachably connected to a top end of the sliding rod 47 through thread. For example, the the sliding rod 47 may be provided with a threaded hole, and a corresponding threaded rod is disposed on the bearing body 461. Through the fit of the threaded rod and the threaded hole, the bearing body 461 may be detachably connected to the top end of the sliding rod 47, to facilitate the quick disassembly of the bearing body 461.

In a case where the bearing body 461 is installed at the top end of the sliding rod 47, the abutment member 462 is squeezed between the bearing body 461 and the sliding rod 47. In this way, the bearing body 461, the abutment member 462 and the sliding rod 47 together form the movable part 43 which may move as a whole. The energy storage member 44 is configured to be pre-pressed between a lower end surface of the abutment member 462 and an upper end surface of the fixing base 41, such that the movable part 43 is pre-pressed on the connecting part as a whole.

### Fourth Embodiment

The present disclosure provides a handling robot, which includes a chassis assembly 1, a tray assembly 2, and a scissor lift assembly 3, the chassis assembly 1 is configured to be supported on a working surface, the tray assembly 2 is disposed above the chassis assembly 1 and configured to bear goods that need to be lifted and lowered, and the scissor lift assembly 3 is disposed between the chassis assembly 1 and the tray assembly 2. The scissor lift assembly 3 includes at least a first connecting rod assembly 310, a second connecting rod assembly 32, and at least two linkage rods 330, the first connecting rod assembly 310 and the second connecting rod assembly 32 are hinged between the chassis assembly 1 and the tray assembly 2 and interlaced with each other, and the at least two linkage rods 330 are hinged to the first connecting rod assembly 310 and the second connecting rod assembly 320 to form a quadrilateral structure. The tray assembly 2 is configured to move relative to the chassis assembly 1 in a height direction under a limitation of the quadrilateral structure, such that the goods on the tray assembly 2 may be stably lifted or lowered. The mode of movement may include translational movement, that is, linear movement in the height direction, or may include other forms of movement.

The first connecting rod assembly 310 and the second connecting rod assembly 320 are connected through the at least two linkage rods 330, and they may cooperate and interact with each other according to a principle of the quadrilateral structure. The first connecting rod assembly 310 and the second connecting rod assembly 320 are able to rotate under the action of external force, and their rotation will cause the quadrilateral structure to deform in the height direction and the horizontal direction, thereby realizing the lifting of the tray assembly 2. The tray assembly 2 may be simultaneously pushed by the first connecting rod assembly 310 and the second connecting rod assembly 320, thereby realizing the linear movement in the height direction.

In solutions of the present disclosure, both the first connecting rod assembly 310 and the second connecting rod assembly 320 of the scissor lift assembly 3 are hinged with the chassis assembly 1 and the tray assembly 2. Compared with an existing scissor-type lifting mechanism, the scissor lift assembly 3 of the present disclosure does not have a sliding pair, and the first connecting rod assembly 310 and the second connecting rod assembly 320 only rotate relative to the chassis assembly 1 and the tray assembly 2, thereby providing more stable support for the tray assembly 2, avoiding the tray assembly 2 to suffer from uneven force in the lifting process, and reducing the influence on the device that provides the driving force.

In some examples of the present disclosure, as shown in FIG. 21, a first end of the first connecting rod assembly 310 and a first end of the second connecting rod assembly 320 that are connected to the chassis assembly 1 are disposed at intervals, and a second end of the first connecting rod assembly 310 and a second end of the second connecting rod assembly 320 that are connected to the tray assembly 2 are also disposed at intervals. The part between the two ends of the first connecting rod assembly 310 and the part between the two ends of the second connecting rod assembly 320 are interlaced with each other. Moreover, the first end of the first connecting rod assembly 310 and the first end of the second connecting rod assembly 320 that are connected to the chassis assembly 1 may be near the two opposite ends of the chassis assembly 1, respectively; and the second end of the first connecting rod assembly 310 and the second end of the second connecting rod assembly 320 that are connected to the tray assembly 2 may be near the two opposite ends of the tray assembly 2, respectively, such that the tray assembly 2 will bear the balanced force and is more stable in the lifting process.

In some examples of the present disclosure, as shown in FIG. 21, the first connecting rod assembly 310 includes a first connecting rod 311 and a second connecting rod 312 which are connected through a first rotation shaft 301 and are able to rotate relative to each other. The first connecting rod 311 is hinged to the tray assembly 2, and the second connecting rod 312 is hinged to the chassis assembly 1. In an example, a first end of the first connecting rod 311 is hinged to the tray assembly 2, and a second end of the first connecting rod 311 is hinged to a first end of the second connecting rod 312 through the first rotation shaft 301. The second end of the second connecting rod 312 away from the first connecting rod 311 is hinged to the chassis assembly 1.

The second connecting rod assembly 320 includes a third connecting rod 321 and a fourth connecting rod 322 which are connected through a second rotation shaft 302 and are able to rotate relative to each other. The third connecting rod 321 is hinged to the tray assembly 2, and the fourth connecting rod 322 is hinged to the chassis assembly 1. In an example, a first end of the third connecting rod 321 is hinged to the tray assembly 2, a second end of the third connecting rod 321 is hinged to a first end of the fourth connecting rod 322 through the second rotation shaft 302, and a second end of the fourth connecting rod 322 away from the third connecting rod 321 is hinged to the chassis assembly 1.

The first connecting rod 311 and the third connecting rod 321 are interlaced with each other, and the second connecting rod 312 and the fourth connecting rod 322 are interlaced with each other. In an example of the present disclosure, as shown in FIG. 21, the first connecting rod 311, the fourth connecting rod 322, and the at least two linkage rods 330 form a quadrilateral structure. It is conceivable for those skilled in the art that, in an example of the present disclosure, the quadrilateral structure of the scissor lift assembly 3 may also be formed by the second connecting rod 312, the third connecting rod 321 and at least two linkage rods 330.

In some examples of the present disclosure, as shown in FIG. 21, the linkage rod 330 include a first linkage rod 3301 and a second linkage rod 3302. A first end of the first linkage rod 3301 is hinged to the first connecting rod 311, and a second end of the first linkage rod 3301 is hinged to the fourth connecting rod 322, and a first end of the second linkage rod 3302 is hinged to the first connecting rod 311, and a second end of the second linkage rod 3302 is hinged to the fourth connecting rod 322.

In an example, the first linkage rod 3301 may be hinged to the fourth connecting rod 322 through the second rotation shaft 302, and the second linkage rod 3302 may be hinged to the first connecting rod 311 through the first rotation shaft 301. Moreover, the first end of the first linkage rod 3301 is hinged between two ends of the first connecting rod 311, and the second end of the second linkage rod 3302 is hinged between two ends of the fourth connecting rod 322.

The quadrilateral structure of the scissor lift assembly 3 may be a regular or irregular quadrilateral structure such as a diamond or a trapezoid, all of which enable the first connecting rod assembly 310 and the second connecting rod assembly 320 to cooperate and interact with each other. In an example of the present disclosure, as shown in FIG. 21, the quadrilateral structure of the scissor lift assembly 3 is set as a parallelogram, the first connecting rod 311 and the fourth connecting rod 322 are parallel to each other, and the first linkage rod 3301 and the second linkage rod 3302 are parallel to each other. In the lifting process, the first connecting rod 311 and the fourth connecting rod 322 rotate synchronously with a same rotation angle, thereby ensuring the translational movement of the tray assembly 2, that is, linear movement in the height direction, such that the goods on the tray assembly 2 may keep balance and avoid slipping off the tray assembly 2.

In some examples of the present disclosure, the first connecting rod assembly 310, the second connecting rod assembly 320 and at least two linkage rods 330 which form the same quadrilateral structure are regarded as a connecting rod unit. In order to further strengthen the stability of the scissor lift assembly 3, at least two connecting rod units may be disposed between the chassis assembly 1 and the tray assembly 2, and the at least two connecting rod units are disposed in parallel with a gap therebetween, and the connecting rod units may be connected through a connecting shaft and move synchronously. In order to increase the lifting height of the scissor lift assembly 3, at least two connecting rod units may be disposed between the chassis assembly 1 and the tray assembly 2, and the at least two connecting rod units are distributed in the height direction and connected end to end in turn.

In some examples of the present disclosure, as shown in FIG. 21, a first bracket 16 and a second bracket 140 are disposed on the chassis assembly 16, the first connecting rod assembly 310 is connected to the first bracket 16 through a third rotation shaft 303. In an example, a lower end of the second connecting rod 312 is connected to the first bracket 16 through the third rotation shaft 303. The second connecting rod assembly 320 is connected to the second bracket through a fourth rotation shaft 304. In an example, a lower end of the fourth connecting rod 322 is connected to the second bracket 140 through the fourth rotation shaft 304.

A third bracket 21 and a fourth bracket 22 are disposed on the tray assembly 2, the first connecting rod assembly 310 is connected to the third bracket 21 through a fifth rotation shaft 305. In an example, an upper end of the first connecting rod 311 is connected to the third bracket 21 through the fifth rotation shaft 305. The second connecting rod assembly 320 is connected to the fourth bracket 22 through a sixth rotation shaft 306. In an example, an upper end of the third connecting rod 321 is connected to the fourth bracket 22 through the sixth rotation shaft 306.

In an example as shown in FIG. 21, the scissor lift assembly 3 includes two connecting rod units disposed in parallel, and any of the first rotation shaft 301, the second rotation shaft 302, the third rotation shaft 303, the fourth rotation shaft 304, the fifth rotation shaft 305 and the sixth rotation shaft 306 may extend transversely and be connected to the two connecting rod units as a connecting shaft. That is, hinge points of the two connecting rod units at corresponding positions may share the same rotation shaft, which is beneficial to improving the stability of the overall structure of the scissor lift assembly 3.

In some examples of the present disclosure, a driving assembly 7 may be included, which is disposed on the chassis assembly 1 or the tray assembly 2, and the driving assembly 7 is configured to drive the first connecting rod assembly 310 to rotate relative to the chassis assembly 1 or the tray assembly 2, or to drive the second connecting rod assembly 320 to rotate relative to the chassis assembly 1 or the tray assembly 2. The first connecting rod assembly 310 and the second connecting rod assembly 320 move synchronously under the restriction of the quadrilateral structure, such that the tray assembly 2 moves in the height direction relative to the chassis assembly 1 to raise or lower the goods on the tray assembly 2.

In an example, the driving assembly 7 is disposed on the chassis assembly 1 to avoid increasing the load of the tray assembly 2. The driving assembly 7 may be connected to the second connecting rod 312 and drive the second connecting rod 312 to rotate, or connected to the fourth connecting rod 322 and drive the fourth connecting rod 322 to rotate.

The driving assembly 7 may adopt a power device that is directly connected to the first connecting rod assembly 310 or the second connecting rod assembly 320 to provide power, or may also include a transmission mechanism connected between the power device and the first connecting rod assembly 310 or the second connecting rod assembly 320 to transmit power. Those skilled in the art may choose a common power device such as a rotating motor, an electric push rod or a hydraulic push rod, as well as a transmission mechanism such as a linkage mechanism, a rack-and-pinion mechanism, or the like.

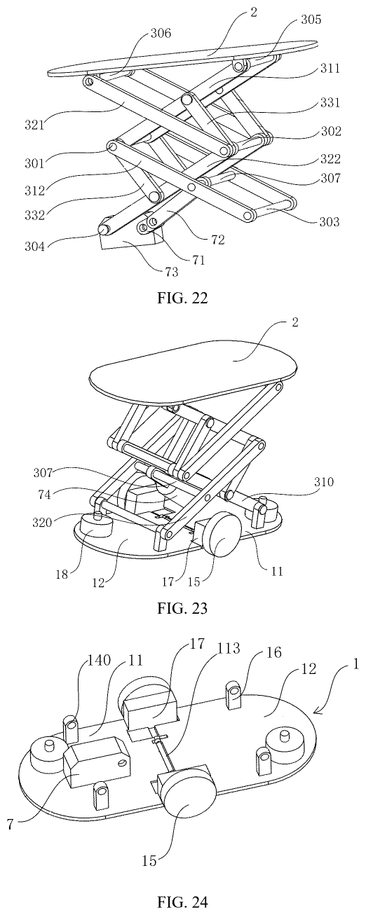

In an example of the present disclosure, as shown in FIG. 22, the driving assembly 7 includes a first driving rod 71 and a second driving rod 72 that are hinged, and a rotating motor 73 fixed on the chassis assembly 1 or the tray assembly 2, the second driving rod 72 is hinged to the first connecting rod assembly 310 or the second connecting rod assembly 320, and the rotating motor 73 is configured to drive the first driving rod 71 to rotate, and drive the first connecting rod assembly 310 or the second connecting rod assembly 320 to rotate through the second driving rod 72.

In examples shown in FIG. 22, the rotating motor 73 is disposed on the chassis assembly 1, and the second driving rod 72 is hinged to the second connecting rod 312 of the first connecting rod assembly 310 to drive the second connecting rod 312 to rotate. The second connecting rod 312 and the fourth connecting rod 322 are disposed at intervals, the rotating motor 73 may be disposed at a position near the fourth connecting rod 322, and the second driving rod 72 may be connected between the two ends of the second connecting rod 312.

In an example of the present disclosure, as shown in FIG. 23, the driving assembly 7 includes a linear driver 74, a body of the linear driver 74 is hinged to the chassis assembly 1 or the tray assembly 2, and an output end of the linear driver 74 is hinged to the first connecting rod assembly 310 or the second connecting rod assembly 320 to directly drive the first connecting rod assembly 310 or the second connecting rod assembly 320 to rotate. The linear actuator 74 may be an electric push rod, a hydraulic cylinder, an air cylinder, or the like, which is not limited by the present disclosure.

In an example of the present disclosure, two connecting rod units are disposed, and the driving assembly 7 may be disposed between the two connecting rod units and may be connected to a connecting shaft between the two connecting rod units to drive the two connecting rod units to move synchronously.

In an example shown in FIG. 22, the connecting shaft between the two connecting rod units includes a seventh rotation shaft 307, and the seventh rotation shaft 307 is connected between the second connecting rods 312 of the two connecting rod units and located at a position between the two ends of the second connecting rod 312. The driving assembly 7 is connected to the seventh rotation shaft 307, and drives the two second connecting rods 312 to rotate synchronously through the seventh rotation shaft 307. Similarly, it is conceivable for those skilled in the art that the seventh rotation shaft 307 may also be connected between the fourth connecting rods 322 of the two connecting rod units, and the driving assembly 7 drives the two fourth connecting rods 322 to rotate synchronously through the seventh rotation shaft 307.

In some examples of the present disclosure, a traveling mechanism for traveling on the working surface is disposed on the chassis assembly 1, and the traveling mechanism may include a traveling wheel, is able to transport the goods to a preset position and lift the goods to a required height position through the scissor lift assembly 3.

In an example, the traveling wheel may include driving wheels 15 disposed at two opposite sides of the chassis assembly 1, and a travel driving device 17, such as a driving motor, that provides power to the driving wheels 15. The traveling wheel may further include an omnidirectional wheel 18 for steering. The two driving wheels 15 are driven by separate travel driving devices 17, and the two travel driving devices 17 may control the two driving wheels 15 to rotate at different rotational speeds to change the traveling direction of the handling robot.

In an example of the present disclosure, as shown in FIG. 23 and FIG. 24, the chassis assembly 1 includes a first chassis 11 and a second chassis 12, which are connected by a transversely extending hinge 113 and is able to rotate relative to each other around the hinge 113. The first connecting rod assembly 310 is hinged to the first chassis 11, and the second connecting rod assembly 320 is hinged to the second chassis 12. The first chassis 11 and the second chassis 12 are distributed front and back in the traveling direction of the chassis assembly 1. When encountering a convex or concave obstacle in the traveling process, the first connecting rod assembly 310 or the second connecting rod assembly 320 may float up and down, which is beneficial to crossing the obstacle and adapting to the uneven road surface.

In some examples of the present disclosure, the driving assembly 7 may be disposed on the first chassis 11 or the second chassis 12. In an example as shown in FIG. 23, the driving assembly 7 is disposed on the first chassis 11 and drives the second connecting rod assembly 320 to rotate relative to the second chassis 12. When the second connecting rod assembly 320 rotates, the second connecting rod assembly 320 drives the first connecting rod assembly 310 to rotate synchronously through the linkage rod 330, so that the tray assembly 2 may be lifted or lowered in the height direction. In an example of the present disclosure, the driving assembly 7 is disposed on the second chassis 12 and drives the first connecting rod assembly 310 to rotate relative to the first chassis 11. When the first connecting rod assembly 310 rotates, the first connecting rod assembly 310 drives the second connecting rod assembly 320 to rotate synchronously through the linkage rod 330, so that the tray assembly 2 may be lifted or lowered in the height direction.

The present disclosure also provides a lifting device, which includes: a base, configured to be supported on a working surface; a tray assembly 2, disposed above the base; and a scissor lift assembly 3. The scissor lift assembly 3 includes at least a first connecting rod assembly 310, a second connecting rod assembly 320 and at least two linkage rods 330, the first connecting rod assembly 310 and the second connecting rod assembly 320 are hinged between the base and the tray assembly 2 and are interlaced with each other, the at least two linkage rods 330 are hinged to the first connecting rod assembly 310 and the second connecting rod assembly 320 to form a quadrilateral structure, and the tray assembly 2 is configured to move relative to the base in a height direction under a limitation of the quadrilateral structure.

It may be understood that the base is the chassis assembly 1 as mentioned above in a case where the lifting device is applied to a movable handling robot, while in a case where the lifting device is applied to an immovable equipment, the function of the base is to support the lifting device on the working surface.

Various embodiments and examples of the present disclosure are described above, and the above description is explanative, not exhaustive, and is not limited to the disclosed embodiments and examples. Some modifications and variations may be apparent to those skilled in the art without departing from the scope and spirit of the illustrated embodiments and examples. Terms used herein are selected to better explain the principles and applications of various embodiments and examples or their technical improvements to technologies in the market, or to enable others skilled in the art to understand various embodiments and examples disclosed herein. It is intended that the scope of the present disclosure is limited by the appended claims.

1. A handling robot, comprising:
a chassis assembly, configured to be supported on a working surface;
a tray assembly, disposed above the chassis assembly and configured to bear a container;
a scissor lift assembly, disposed between the chassis assembly and the tray assembly and configured to drive the tray assembly up or down relative to the chassis assembly;
a driving device, configured to drive movement of the scissor lift assembly to drive the tray assembly up or down relative to the chassis assembly; and
a supporting part, configured to support the tray assembly in a case where the tray assembly is lowered to a preset height.

2. The handling robot of claim 1, wherein driving wheels are disposed at two opposite sides of the chassis assembly, and the supporting part is disposed at a position near the driving wheel.

3. The handling robot of claim 1, wherein the supporting part is disposed on the chassis assembly and is configured to extend upward such that the tray assembly is supported on the supporting part in the case where the tray assembly is lowered to the preset height; or
the supporting part is disposed on the tray assembly and is configured to extend downward such that the tray assembly is supported on the chassis assembly through the supporting part in the case where the tray assembly is lowered to the preset height.

4. (canceled)

5. The handling robot of claim 1, wherein the supporting part is an assistive assembly, and the assistive assembly is disposed between the chassis assembly and the tray assembly; and the tray assembly is configured to move to an initial position under control of the driving device and by resisting against an elastic force of the assistive assembly, and/or is configured to move to a lifting position under control of the driving device and under the elastic force of the assistive assembly.

6. The handling robot of claim 5, wherein the assistive assembly is configured to be pre-pressed between the tray assembly and the chassis assembly during a movement of the tray assembly relative to the chassis assembly;
the assistive assembly is configured to be pre-pressed between the tray assembly and the chassis assembly after the tray assembly moves a preset distance from the lifting position to the initial position; and is configured to detach from the chassis assembly or the tray assembly after the tray assembly moves a preset distance from the initial position to the lifting position.

7. (canceled)

8. The handling robot of claim 5, wherein the assistive assembly is configured to extend in a vertical direction and comprises a connecting part and a movable part pre-pressed on the connecting part; the connecting part is secured to the chassis assembly, and the movable part is configured for fitting with the tray assembly; or the connecting part is secured to the tray assembly, and the movable part is configured for fitting with the chassis assembly.

9. The handling robot of claim 8, wherein a rolling part is disposed between the chassis assembly and the movable part, and the chassis assembly is configured to rollably fit with the movable part through the rolling part; and the rolling part is configured to roll between the chassis assembly and the movable part in a case where the tray assembly rocks relative to the chassis assembly; or
a rolling part is disposed between the tray assembly and the movable part, and the tray assembly is configured to rollably fit with the movable part through the rolling part; and the rolling part is configured to roll between the tray assembly and the movable part in a case where the tray assembly rocks relative to the chassis assembly.

10.-11. (canceled)

12. The handling robot of claim 8, wherein the connecting part comprises a fixing base and a guiding rod extending from the fixing base in a vertical direction; the movable part is sleeved on the guiding rod; an energy storage member is disposed between the fixing base and the movable part, and the energy storage member is configured to make the movable part have a tendency to move away from the fixing base to provide a vertically upward elastic force to the tray assembly; or
the connecting part comprises a fixing sleeve, and the movable part is configured to be movably connected within the fixing sleeve; and an energy storage member is disposed between the fixing sleeve and the movable part, and is configured to make the movable part have a tendency to move outward to provide a vertically upward elastic force to the tray assembly.

13.-14. (canceled)

15. The handling robot of claim 12, wherein the movable part comprises a sliding rod and a bullseye bearing; the sliding rod is configured to be slidably connected within the fixing sleeve and is configured to have a tendency to move outward under an action of the energy storage member; and the bullseye bearing is configured to be detachably connected to a top end of the sliding rod and is configured to abut against the chassis assembly or the tray assembly.

16.-17. (canceled)

18. The handling robot of claim 5, satisfying at least one of:
Fp≥G1+G2−F, where F≤G1,
Fp≥G1+G2−F, where G1<F<G1+G2/2;
Fp≥G2/2, where F=G1+G2/2; or
Fp≥F−G, where F>G1+G2/2,
wherein G1 represents a force downward caused by gravity of the tray assembly in an unloaded state, G2 represents a maximum container weight bearable by the tray assembly; F represents a maximum elastic force of the assistive assembly in a case where the tray assembly is at the initial position, and Fp represents a peak driving force provided by the driving device.

19. (canceled)

20. The handling robot of claim 1, wherein the chassis assembly comprises a first chassis and a second chassis hinged to the first chassis; and the first chassis and the second chassis are configured to be co-supported on the working surface; and
the scissor lift assembly comprises at least a first scissor arm and a second scissor arm hinged together; a bottom of one of the first scissor arm and second scissor arm is connected to a position on the first chassis away from the second chassis; and a bottom of the other one of the first scissor arm and second scissor arm is connected to a position on the second chassis away from the first chassis.

21. The handling robot of claim 20, wherein the supporting part is a supporting assembly disposed on the first chassis and protruded from an end surface of the first chassis; and the tray assembly is configured to be supported on the supporting assembly in a case where the tray assembly is lowered to the preset height;
wherein driving wheels are disposed at two opposite sides of the chassis assembly, and the supporting assembly is configured to extend upward beyond the driving wheel;
wherein the supporting assembly is disposed at a position on the first chassis near the driving wheel.

22.-23. (canceled)

24. The handling robot of claim 20, wherein a driving wheel is disposed on the first chassis, the supporting part is an assistive assembly, the tray assembly is configured to apply a positive pressure to such a position of the chassis assembly that corresponds to the driving wheel through the assistive assembly; and the assistive assembly is disposed at such a position of the first chassis, the second chassis or the tray assembly that is near the driving wheel.

25. The handling robot of claim 20, wherein the driving device is disposed on the scissor lift assembly, and the driving device is configured to drive the second scissor arm to rotate relative to the first scissor arm.

26. The handling robot of claim 25, wherein at least two first scissor arms and at least two second scissor arms are provided, the at least two first scissor arms are connected at bottom through a first rotating shaft, the at least two second scissor arms are connected at bottom through a second rotating shaft; and the driving device is disposed between the first rotating shaft and the second rotating shaft, and is configured to drive the first rotating shaft and the second rotating shaft to move away from or close to each other.

27.-35. (canceled)

36. The handling robot of claim 1, wherein the chassis assembly comprises a first chassis and a second chassis hinged to the first chassis; and the first chassis and the second chassis are configured to be co-supported on the working surface; and
the handling robot further comprises a movable platform, a first side of the movable platform is hinged to the second chassis, and a second side of the movable platform is movably connected to the first chassis; and the scissor lift assembly is disposed between the movable platform and the tray assembly and is configured to drive the tray assembly up or down relative to the chassis assembly.

37.-38. (canceled)

39. The handling robot of claim 36, wherein the supporting part is disposed on the movable platform or at a position on the tray assembly near a driving wheel, and the tray assembly is configured to apply a positive pressure to such a position of the chassis assembly that corresponds to the driving wheel through the supporting part and the movable platform; or
wherein the supporting part is disposed at such a position of the first chassis, the second chassis or the tray assembly that is near the driving wheel and is configured to penetrate the movable platform.

40.-59. (canceled)

60. A handling robot, comprising:
a chassis assembly, configured to be supported on a working surface;
a tray assembly, disposed above the chassis assembly and configured to bear a container;
a scissor lift assembly, disposed between the chassis assembly and the tray assembly, and configured to drive the tray assembly up or down relative to the chassis assembly; and
a driving device, configured to drive movement of the scissor lift assembly to drive the tray assembly up or down relative to the chassis assembly, wherein the driving device is disposed on scissor lift assembly.

61. The handling robot according to claim 60, wherein the scissor lift assembly comprises two scissor arms hinged together, the driving device is configured to drive one of the two scissor arms to rotate relative to the other one of the two scissor arms to make the two scissor arms close to or away from each other at top and bottom to increase or decrease a size of the scissor lift assembly in a height direction.

62. The handling robot according to claim 61, wherein the driving device is connected to the two scissor arms to drive one of the two scissor arms to rotate relative to the other one of the two scissor arms;
the scissor lift assembly comprises a rotating shaft and at least two pairs of scissor arms, each pair of scissor arms comprise the two scissor arms, and one of the two pairs of scissor arms is connected with the other one of the two pairs of scissor arms by the rotating shaft; and
the driving device is connected to the rotating shaft to drive rotation of the rotating shaft to drive movement of the scissor arms.
